(19) United States
(12) Patent Application Publication
(10) Pub. No.: US 2007/0296369 A1
(43) Pub. Date: Dec. 27, 2007

(54) Thin linear, rotary, and step motor and electromagnet driver using printed coil board

(75) Inventor: Showway Yeh, Cupertino, CA (US)

Correspondence Address: SHOWWAY YEH, 21845 HERMOSA AVE., CUPERTINO, CA, 95014, US

(73) Assignee: Showway Yeh, Cupertino, CA (US)

(21) Appl. No.: 11/162,620

(22) Filed: Sep. 16, 2005

(51) Int. Cl. H02K 11/00; G05B 19/40; H02K 37/00; H02K 5/00; H02P 8/28; H02P 3/08; H02K 41/03; H01F 5/00

(52) U.S. Cl. 318/696; 310/12; 310/49 A; 310/68 R; 310/89; 318/135; 318/685; 336/200

(57) ABSTRACT

This invention first presents winding methods to make multiple printed coils on a thin multi-layered PCB. Multiple thin magnets can be laterally installed on a thin magnet board, too. Then, this invention presents variant but similar conceptual models of thin linear, rotary, and step motors and electromagnetic driver using such thin coil PCBs and magnet boards or just coil PCBs as the stators and the actuator. All models share similar innovation. Each printed coil or magnet of the actuator has the same polarity with the printed coils or magnets of the stators at its leading edge and/or has the opposite polarity with the printed coils or magnets of the stators at its tailing edge in the moving direction. So that each printed coil or magnet of the actuator is pulled by the printed coils or magnets of the stators at its leading edge and/or pushed by the printed coils or magnets of the stators at its tailing edge. The electromagnetic force that the actuator moves receives is the summation of the force that all printed coils or magnets of the actuator receive. As the result, the actuator moves in the desired direction. The electromagnetic polarities of the printed coils of the actuator or the stators may need to be changed during the operation to assure that this happens. Then the motor can be a step motor by counting the number of times that some printed coils change the electromagnetic polarities. The motors and the electromagnetic drivers are so thin that the apparatus using them can be comfortably carried under the user's clothes or attached to the user's skin.

### FIELD OF INVENTION

The present invention relates to using the printed circuit board to make thin printed coils and using such printed coils to make thin linear, rotary, and step motors and electromagnetic drivers.

### PREVIOUS ARTS

| U.S. Pat. No. | Inventor | Date |
|---|---|---|
| 6,664,664 | Botos, et al | Dec. 16, 2003 |
| 5,304,886 | Yang | Apr. 19, 1994 |
| 4,962,329 | Fujita, et al | Oct. 09, 1990 |

### BACKGROUND

Using the printed circuit board (PCB) technology or similar technology, the printed coils can be very thin. Such a thin printed coil may not generate enough electromagnetic force for the application, as the number of windings may be too small. Any number of such printed coils can be laterally built on a PCB. If the windings of the printed coils on a PCB are properly connected, the total electromagnetic force can be large. In the other words, a conventional coil can be chopped into a number of thin coils built in a thin PCB. Also, any number of thin and small magnets can be built in a thin board. Then, arranging such coil PCBs and magnet boards or just coil PCBs to be stators and actuator, the motors and the electromagnetic drivers can produce enough force yet be very thin. This kind of thin motors or drivers are perfect to be applied to the thin apparatuses operated by battery and carried under the user's clothes. For example, it can be applied to the thin medication infusion system carried under the user's clothes or attached to the user's skin. It can also be installed in the user's helmet or jacket to circulate the air.

The PCB is made by laminating a number of layers. Each layer is further composed of a conducting sub-layer and a dielectric sub-layer. Usually, the conducting sub-layer is copper and the dielectric sub-layer is fiberglass. The conducting sub-layer is chemically etched to be the electrical conducting paths. Tiny holes, called vias, are made on the dielectric sub-layers and are filled with conducting material so that conducting paths on different layers are connected. A conducting sub-layer can be etched to be windings of the printed coils. A number of layers can be laminated to form printed coils where the windings are aligned. The printed coils can be significantly thinner than the conventional ones.

Furthermore, the coil PCB and the magnet board can be flexible. So, the stators and the actuator of the motor can be flexible. Bending the motor, the coils and magnets of the stators and the actuator will not be exactly aligned. The motor still can work if the stators and the actuator are not biased too much and the friction is overcome.

The printed linear motor disclosed in U.S. Pat. No. 6,664,664 by Botos, et al presents a conceptual model of linear motor that is operated by multi-phase electricity. A one-dimensional array of multi-layer printed coils on the actuator interacts with one or two one-dimensional arrays of magnets on the stator(s) to move along a track. The windings of adjacent printed coils are isolated. It needs at least one via for each winding of each printed coil in average. Since making vias is expensive, their invention is unattractive because the number of vias can be reduced in half if the windings of adjacent printed coils on the same layer are connected. Also, their invention uses through vias only. Each through via will occupy a certain area. The diameter of a via is few times than the width of a conducting path. So, in their invention, the total area of all vias can have large percentage of the whole PCB if the printed coil needs to be small. The device can be even smaller if buried vias are used.

The printed-circuit step motor disclosed in U.S. Pat. No. 5,304,886 by Yang presents a conceptual model of rotary step motor using old PCB technology where two rings of single-layer windings are built on the two sides of the rotary actuator, respectively. The windings interact with two rings of magnets on the two stators, respectively. The two rings of windings work inter-changeably. Using multi-layer and multi-ring of windings as presented in the present invention will have much better efficiency and significantly reduce the size of the device. Also, in their invention, half of the coils do not create the electromagnetic force at any moments because the coils are changing the electromagnetic polarities. In my present invention, the number of the coils that are changing the electromagnetic polarities at any moment is 1/n of the total where n is any positive number.

The printed-circuit armature coil disclosed in U.S. Pat. No. 4,962,329 by Fujita, et al presents a conceptual model of armature that is formed by wrapping a strip of two-layer windings of PCB. It is used for a round disk shape armature where the electromagnetic polarities are radial from the center. It is hard to be applied to the small coils to be carried under the user's clothes.

The present invention first presents different winding methods for the coil PCB. Then, it presents the conceptual models of thin linear, rotary, and step motors using the coil PCBs and the magnet boards or just the coil PCBs.

### OBJECTS AND ADVANTAGES

My present invention presents conceptual models of thin linear, rotary, and step motors and electromagnetic drivers using printed coils. The apparatuses, like the pumps, using these motors or drivers can be very thin. The users of the apparatuses will feel convenient and comfortable to carry the apparatuses under their clothes or to attach the apparatuses to their skin.

### DRAWING FIGURES

FIG. 1A: The winding method of a stand alone printed coil.

FIGS. 1B and 1C: The examples of winding methods to form a one-dimensional array of printed coils that change the polarity at the same time.

FIGS. 2A to 2D: Connecting printed coils in series and changing the polarities of the printed coils.

FIG. 3A: A two-dimensional array of thin printed coils or magnets where the polarities of the printed coils or the magnets are perpendicular to the plan of the array.

FIGS. 3B and 3C: The principle of the thin and flat motor whose actuator and stator laterally comprise multiple thin and small printed coils or magnets.

FIG. 4A: The top view of the stators and the actuator that are three arrays of printed coils or magnets of a thin linear motor and their relative positions.

FIG. 4B: The vertical cross section view of a thin linear motor.

FIGS. 4C and 4D: The vertical cross section view of the printed coils or magnets of the stators and the actuator of the conceptual model of the thin linear motor showing their polarities to work.

FIGS. 5A to 5C: The vertical cross section view of the printed coils or the magnets of the stators and the actuator of the second conceptual model of the thin linear motor showing their polarities to work.

FIGS. 5D and 5E: The mechanism to change the electromagnetic polarities of the printed coils.

FIGS. 6A to 6C: The vertical cross section view of the printed coils or the magnets of the stators and the actuator of the third conceptual model of the thin linear motor showing their polarities to work.

FIG. 7: The top view of the linear motor whose actuator is attached to a spring.

FIG. 8A: The top views of the two stators and the actuator of the conceptual model of the thin rotary motor using rings of thin printed coils and/or magnets.

FIGS. 8B to 8D: The side views of the rings that spread linearly to show the polarities.

FIG. 8E: The mechanism to change the polarities of the printed coils.

FIG. 9A: The top view of the stator and the actuator of another conceptual model of the thin rotary motor using rings of thin printed coils and/or magnets.

FIGS. 9B to 9D: The side views of the rings that spread linearly to show the polarities.

FIG. 10: The conceptual model of electromagnetic driver where the electromagnetic polarities are perpendicular to the plan of the driver.

FIG. 11A: The substrate of a two-dimensional array of printed coils whose the polarities are parallel with the plan of the substrate.

FIG. 11B: The two dimensional array of printed coils.

FIG. 11C: The resulted one-dimensional array of printed coils.

FIGS. 12A to 12D: The top views of the conceptual models of the linear motor and the electromagnetic driver explained above where the polarities are parallel with the plan of the motor.

### SUMMARY

This invention first presents winding methods to make multiple printed coils on a thin multi-layered PCB. Multiple thin magnets can be laterally installed on a thin magnet board, too. Then, this invention presents variant conceptual models of thin linear, rotary, and step motors and electromagnetic driver using such thin coil PCBs and magnet boards or just coil PCBs as the stators and the actuator. All models share similar innovation. Each printed coil or magnet of the actuator has the same polarity with the printed coils or magnets of the stators at its leading edge and/or has the opposite polarity with the printed coils or magnets of the stators at its tailing edge in the moving direction. So that each printed coil or magnet of the actuator is pulled by the printed coils or magnets of the stators at its leading edge and/or pushed by the printed coils or magnets of the stators at its tailing edge. The electromagnetic force that the actuator moves receives is the summation of the force that all printed coils or magnets of the actuator receive. As the result, the actuator moves in the desired direction. The electromagnetic polarities of the printed coils of the actuator or the stators may need to be changed during the operation to assure that this happens. Then the motor can be a step motor by counting the number of times that some printed coils change the electromagnetic polarities. The motors and the electromagnetic drivers are so thin that the apparatus using them can be comfortably carried under the user's clothes or attached to the user's skin.

### DETAIL DESCRIPTION

The following will first explain the winding methods of the coil PCB where printed coils are built on the coil PCB. Then, using the coil PCBs or the coil PCBs and the magnet boards, thin linear, rotary, and step motors are built.

Windings of Coil PCB

In the following, the notation W_{i,j} represents the winding of the printed coil Cⱼ on the layer Lᵢ of a PCB.

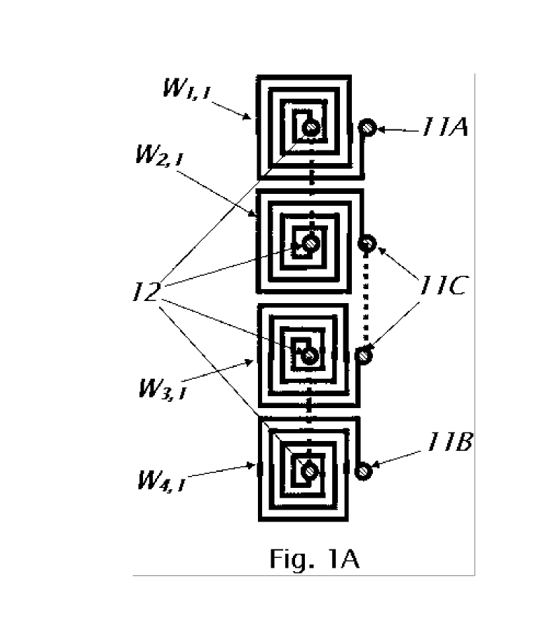

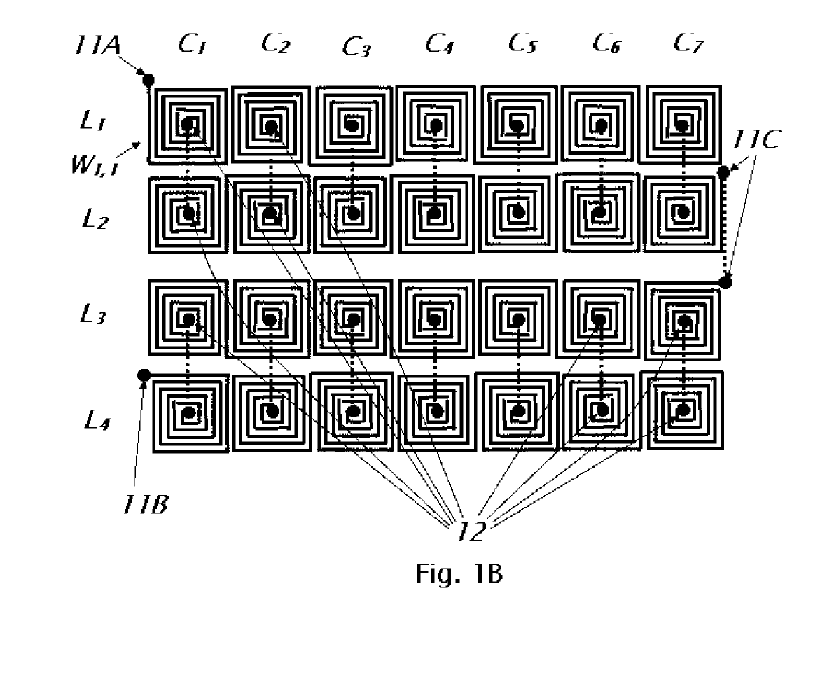

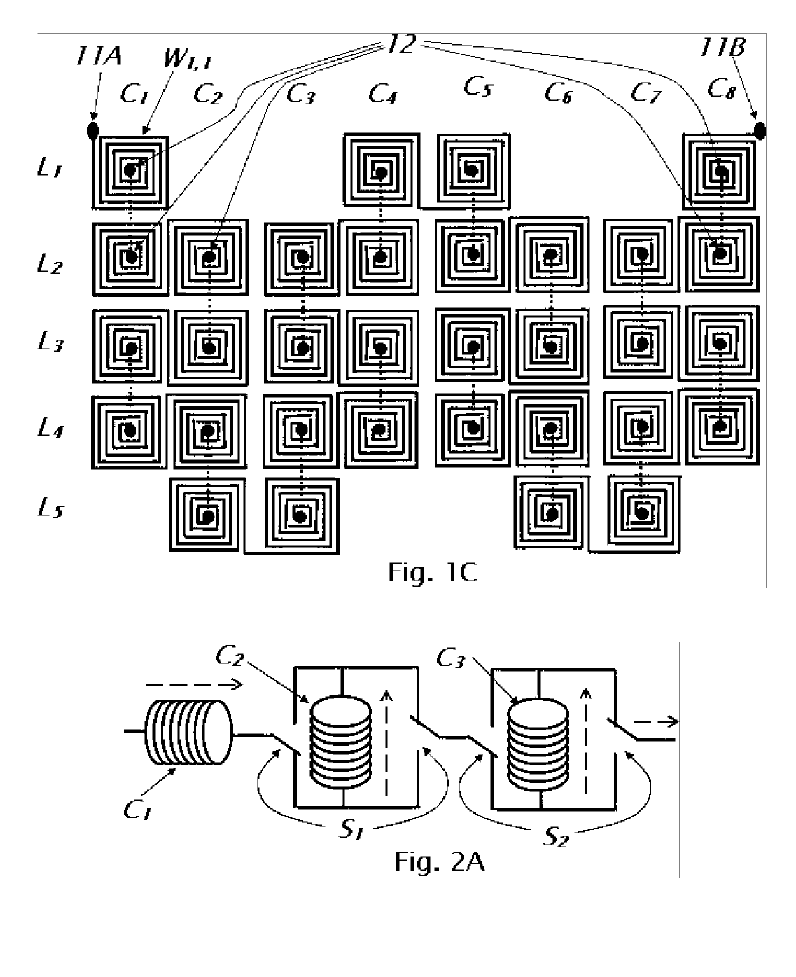

Intuitively, the windings of a coil can be made as FIG. 1A shows. The coil C₁ is built on a 4-layer PCB. Each layer Lᵢ contains the winding W_{i,1}. The wiring path starts with the terminal perimeter 11A of the winding W_{1,1}, and spirals clockwise from the perimeter to the center and goes down to the center of the winding W_{2,1} following the buried via 12. Then, it follows the winding clockwise from the center to the perimeter. Then, it goes down to the perimeter of the winding W_{3,1} following the buried via 11C. It continues until it exits the winding W_{4,1} at the terminal perimeter 11B. In average, there is one buried via per coil per dielectrical layer. Since making vias is expensive, the following shows the winding methods to save the vias in half.

In FIG. 1B, the one-dimensional array of printed coils C₁ to C₇ are connected and built in the PCB having layers L₁ to L₄. The wiring path starts with the terminal perimeter 11A of the winding W_{1,1} and spirals counterclockwise from the perimeter to the center. It exits at the center and goes down to the center of the winding W_{2,1} following the buried via 12. Then, it follows the winding counterclockwise from the center to the perimeter. It continues to enter the winding W_{2,2} that spirals clockwise from the perimeter to the center. The path exits at the center and follows the buried via 12 to go up to the center of the winding W_{1,2} that spirals clockwise from the center to the perimeter. Then, it enters the winding W_{1,3} that spirals counterclockwise from the perimeter to the center. This path continues until it exits the winding W_{2,7} counterclockwise at the perimeter. The via 11C connects the perimeters of the windings W_{2,7} and W_{3,7}. The winding W_{3,7}on the third layer spirals counterclockwise from the perimeter to the center. Then, the wiring follows the buried via 12 at the center to go down to the center of the winding W_{4,7}that spirals counterclockwise from the center to the perimeter. The wiring continues the windings W_{4,6}, W_{3,6}, W_{3,5}, W_{4,5}, W_{4,4}, . . . until it exits the winding W_{4,1} at the terminal perimeter 11B. All windings W_{x,i} for each printed coil Cᵢ have the same winding direction and, hence, have the same polarity and every two consecutive printed coils Cᵢ and Cᵢ₊₁ have opposite polarities when the electrical current is applied to the terminal perimeters 11A and 11B. The terminal perimeters 11A and 11B are connected to the power source or other series of connected printed coils. Note that the layer Lᵢ and the layer Lᵢ₊₁ can be exchanged where i is an odd number.

FIG. 1C shows another example that eight consecutive printed coils C₁ to C₈ are built in the PCB layers L₁ to L₅. The conducting path starts with the terminal perimeter 11A at the perimeter of the winding W_{1,1} that spirals counterclockwise from the perimeter to the center. Then, it follows the buried via to go down to the center of the winding W_{2,1} that spirals counterclockwise from the center to the perimeter. The path continues to enter the winding W_{2,2} that spirals clockwise from the perimeter to the center. Then, it follows the buried via to go down to the center of the winding W_{3,2} that spirals clockwise from the center to the perimeter. Then, it enters the winding W_{3,1} that spirals counterclockwise from the perimeter to the center. This path continues until it exits the winding W_{5,2} clockwise at the perimeter that is connected to the perimeter of the winding W_{5,3} that spirals counterclockwise from the perimeter to the center. Then, it goes up to the center of the winding W_{4,3} that spirals counterclockwise from the center to the perimeter. The path continues the windings W_{4,4}, W_{3,4}, W_{3,3}, . . . until it exits the winding W_{1,4} at the perimeter and enters the winding W_{1,5} from the perimeter to the center. Then, repeat the winding until it exits the winding W_{1,8} at the terminal perimeter 11B. The terminal perimeters 11A and 11B are connected to the power source or to the windings of another printed coils. All windings W_{x,i} for each printed coil Cᵢ have the same winding direction and, hence, have the same polarity and every two consecutive printed coils Cᵢ and Cᵢ₊₁ have opposite polarities when the electrical current is applied to the terminal perimeters 11A and 11B.

The method of FIG. 1B is good for even number of layers. The centers of all windings on the odd numbered layers are connected to the centers of the windings on the layers immediate beneath. If the PCB has odd number of layers, the method of FIG. 1C is good that does not require perimeter-to-perimeter vias. The centers of a half of the windings on each layer are connected upward and those of the other half are connected downward. The method of FIG. 1A is good for stand alone coil. A minor concern for the method of FIG. 1B is that, when there are even number of coils, the wiring starts on the layer Lᵢ will end on the same layer and then goes down two layers to the layer Lᵢ₊₂. An alternative is to divide the coils into two groups each having odd number of coils. For the first group, the wiring starts on the layer Lᵢ and ends on the layer Lᵢ₊₁ and then goes down one layer to the layer Lᵢ₊₂. The wiring comes back to the layer Lᵢ₊₁ of the second group with a via passing through one layer. So, it is a trade off between one two-layer via and two one-layer vias. So, practically, these winding methods are mixed.

In general, the windings belonging to a set of printed coils where the electrical current is applied to all printed coils at the same time and the polarities of all printed coils do not change or change at the same time during the operation are connected in series. A PCB may contain any sets of connected coils. The windings of a printed coil on different layers are aligned. The center of each winding of each printed coil is connected to the center of the winding of the same printed coil on the layer either immediate beneath or immediate above but not both with a buried via. The wiring polarity of the two windings connected at the center is the same where one is from the perimeter to the center and the other is from the center to the perimeter. Then, the perimeters of every two adjacent windings on the same layer are connected in series with a path. There may be few exceptions for connection convenience. There are not loops. There are two terminal perimeters for each series of connected windings. Then, the terminal perimeters of every two series of connected windings are connected with a via or with a via and paths. A series of connected windings in the set is formed without any loops. The connection ensures that, when the electrical current is applied to the two terminal perimeters, all windings of the same printed coil produce magnetic flux with the same polarity. The polarities of the printed coils in the same set may be different. The connection also ensures that the relative polarities of the printed coils are correct.

If the impedance of the connected printed coils is too large to be connected to the power sources, the series of the connected windings is divided into smaller series so that each series of connected windings is appropriate to be connected to the power sources. The dividing point is at the perimeters of two windings of two adjacent printed coils. Each perimeter at the dividing point becomes a terminal perimeter and is connected to the power source.

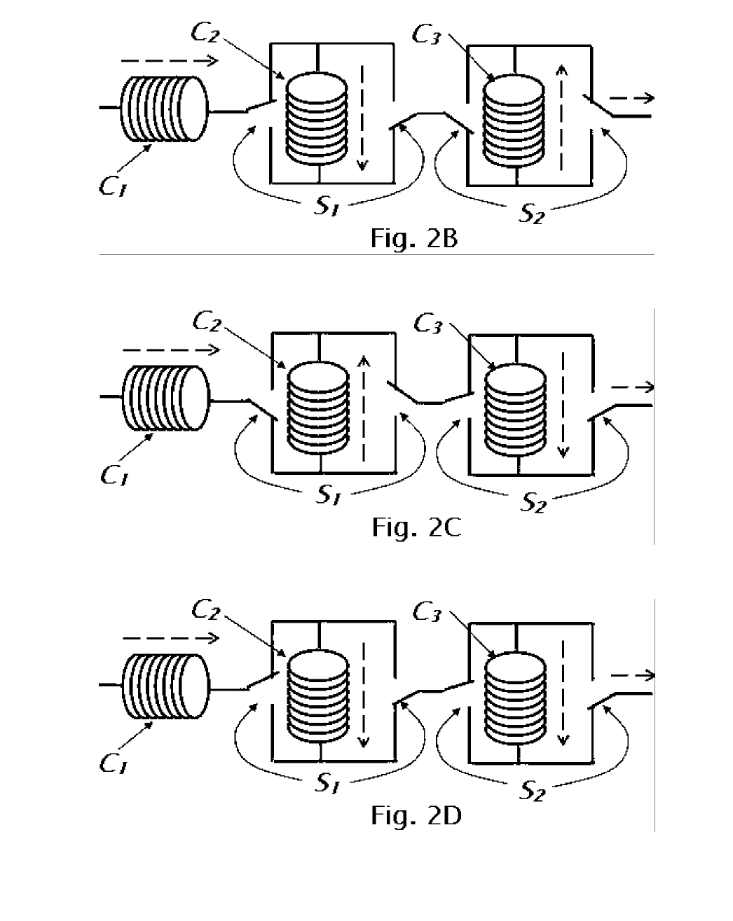

The impedance of all windings of the printed coils that change the polarities at the same time may be too small to be connected to the power source. Then, the windings of the printed coils that change the polarities at different moments of time but the total duration of operation is the same are connected in series with switches to have appropriate impedance. FIGS. 2A to 2D show an example. The printed coils C₁, C₂, and C₃ are connected in series. The polarity of the printed coil C₁ is not changed. The polarities of the printed coils C₂ and C₃ are controlled by the switches S₁ and S₂, respectively, that are controlled by the controller. As shown in FIG. 2A, the printed coils C₁, C₂, and C₃ are connected in series and the polarities of the printed coils C₂ and C₃ are bottom up. If the switch S₁ is changed as shown in FIG. 2B, the printed coils C₁, C₂, and C₃ are still connected in series but the polarity of the printed coil C₂ is changed to be top down. FIG. 2C shows that the switch S₂ is changed so that the polarity of the printed coil C₃ is changed to be top down. FIG. 2D shows that both switches S₁ and S₂ are changed so that the polarities of the printed coils C₂ and C₃ are changed. If the impedance of the series of connected windings is still too small to be connected to the power sources, a resistor may be connected to the series of windings to have appropriate impedance.

The Thin Printed Motor

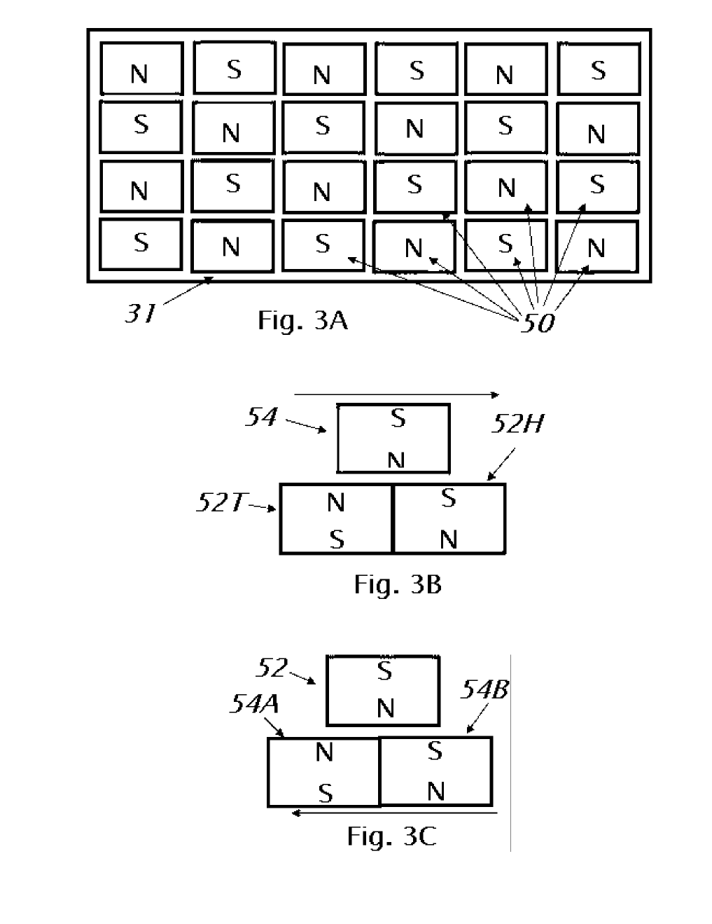

FIG. 3A shows an example that twenty-four printed coils 50 are built on a substrate 31. The array may be built on a coil PCB. Every two consecutive printed coils have opposite polarities in this example. The PCB can be flexible so that the motor using it is flexible. The magnets can be made to be thin and small and are laterally installed on a magnet board similar with the coil PCB shown in FIG. 3A. The magnet board can be flexible, too.

The principle to make motor with the boards of the printed coils and the magnets or just the printed coils is to arrange the boards so that each printed coil or magnet of the actuator has the same electromagnetic polarity with that of the stators at its leading edge and/or has the opposite electromagnetic polarity with that of the stators at its tailing edge. An example is shown in FIG. 3B. The leading and the tailing edges of the printed coil or magnet 54 of the actuator are aligned with the printed coils or magnets 52H and 52T; respectively, of the stator. Since the printed coil or magnet 54 of the actuator has the same polarity with the printed coil or magnet 52H, the former is pulled to the right by the latter. Since the printed coil or magnet 54 has the opposite polarity with the printed coil or magnet 52T; the former is pushed to the right by the latter. Hence, each printed coil or magnet of the actuator is pulled by the printed coils or the magnets of the stators at its leading edge and/or is pushed by the printed coils or the magnets of the stators at its tailing edge. So, the actuator receives net force to move in the desired direction. On the other hand, an example is shown in FIG. 3C. The leading and the tailing edges of the printed coil or magnet 52 of the stator are aligned with the printed coils or magnets 54A and 54B, respectively, of the actuator. The printed coil or magnet 52 has the same polarity with the printed coil or magnet 54B. The former pulls the latter to the left. The printed coil or magnet 52 has the opposite polarity with the printed coil or magnet 54A. The former pushes the latter to the left. Hence, each printed coil or magnet of the stator pulls the printed coils or the magnets of the actuator at its tailing edge and/or pushes the printed coils or the magnets of the actuator at its heading edge. So, the actuator receives net force to move in the desired direction.

The following presents few conceptual models to do so. For each model, there are three configurations: the stators are arrays of printed coils and the actuator is an array of magnets; the stators are arrays of magnets and the actuator is an array of printed coils; and the stators and the actuator are arrays of printed coils.

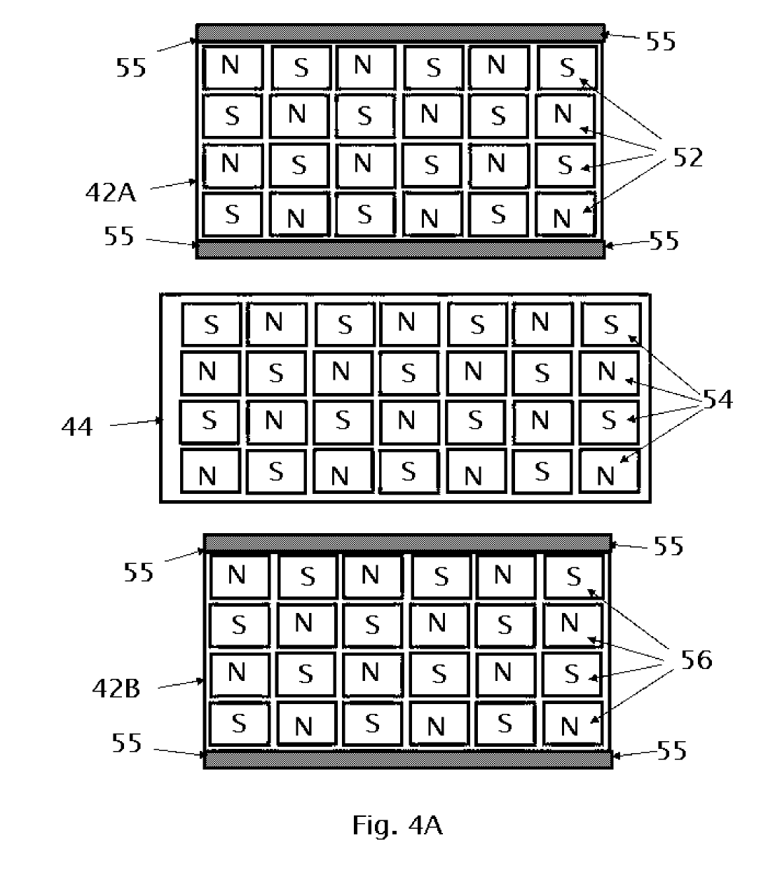

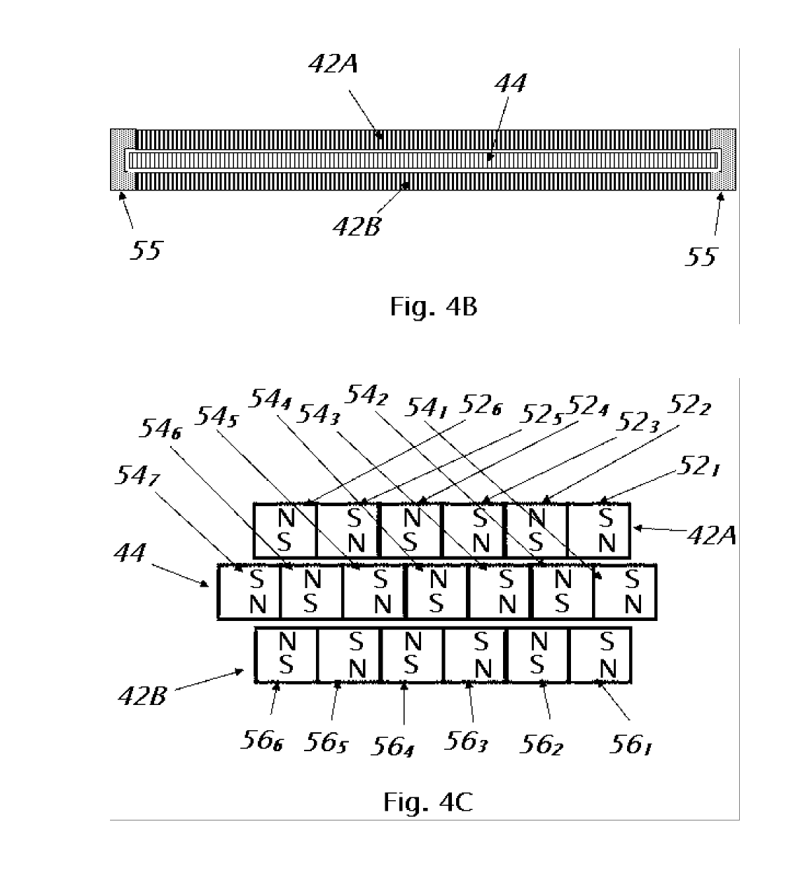

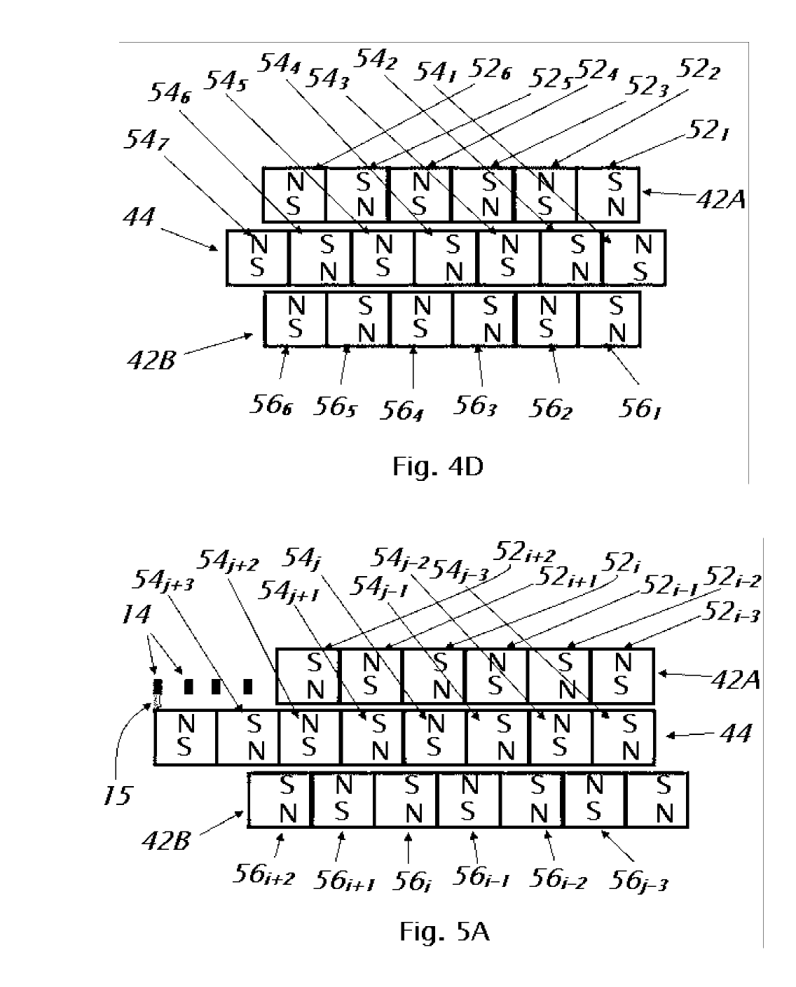

FIG. 4A shows the polarities and the relative positions of the printed coils and/or the magnets of the top view of the two stators 42A and 42B and the actuator 44 of the conceptual model of a thin linear motor. FIG. 4B shows its cross section view. Assume that the actuator 44 is composed of printed coils and the controller changes the polarities of the printed coils of the actuator to control the movement of the actuator. The stators 42A and 42B are separated by the track 55. The actuator 44 moves along the track 55 between the stators 42A and 42B. FIGS. 4C and 4D show the polarities of the printed coils and/or the magnets of three corresponding rows, one from each of the two stators and the actuator, as an example. The polarities of the printed coils or magnets of each row of the actuator 44 and the stators 42A and 42B are alternating. As shown in FIG. 4C, the polarity of the printed coil 54ⱼ of the actuator 44 is the same as that of the printed coils or magnets 52ⱼ and 56ⱼ of the stators 42A and 42B, respectively, and is opposite with that of the printed coils or magnets 52ⱼ₋₁ and 56ⱼ₋₁ of the stators 42A and 42B, respectively. Therefore, the printed coil 54ⱼ is pulled to the left by the printed coils or magnets 52ⱼ and 56ⱼ and is pushed to the left by the printed coils or magnets 52ⱼ₋₁ and 56ⱼ₋₁. So, the actuator 44 is driven to the left by the two stators 42A and 42B. FIG. 4D shows that the direction of the current applied to all printed coils of the actuator 44 is reversed and, hence, the polarities of all printed coils of the actuator 44 are reversed. Then, the printed coil 54ⱼ is pushed to the right by the printed coils or magnets 52ⱼ and 56ⱼ and is pulled to the right by the printed coils or magnets 52ⱼ₋₁ and 56ⱼ₋₁. Hence, the actuator 44 is driven to the right. Therefore, the action of the actuator 44 is controlled by applying the current with correct polarity to the printed coils of the actuator 44.

If the stators 42A and 42B comprise printed coils, the action of the actuator 44 can also be controlled by applying the current with correct polarity to the printed coils of the stators 42A and 42B. Also, there may be only one stator. Since these two models are obvious, the figures are not shown.

The maximum distance that the actuator of the above model can move is the distance between two consecutive printed coils. The actuator either is blocked to stop by something pre-installed in the way or moves to where the printed coils of the actuator are aligned with the printed coils or magnets of the stators and stops.

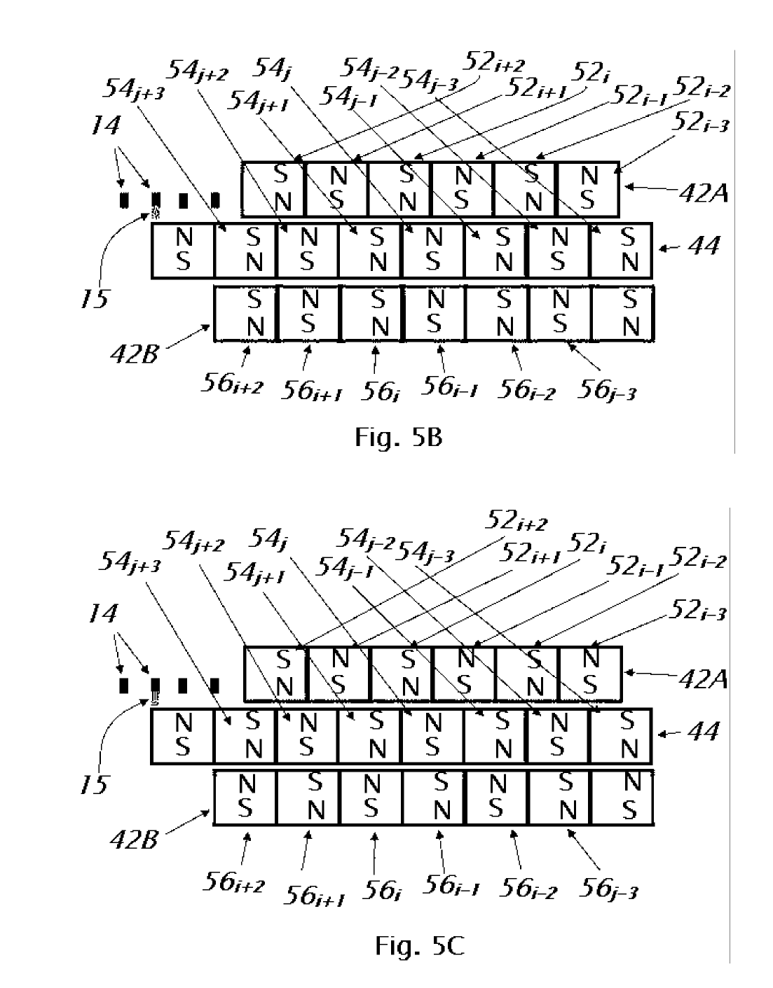

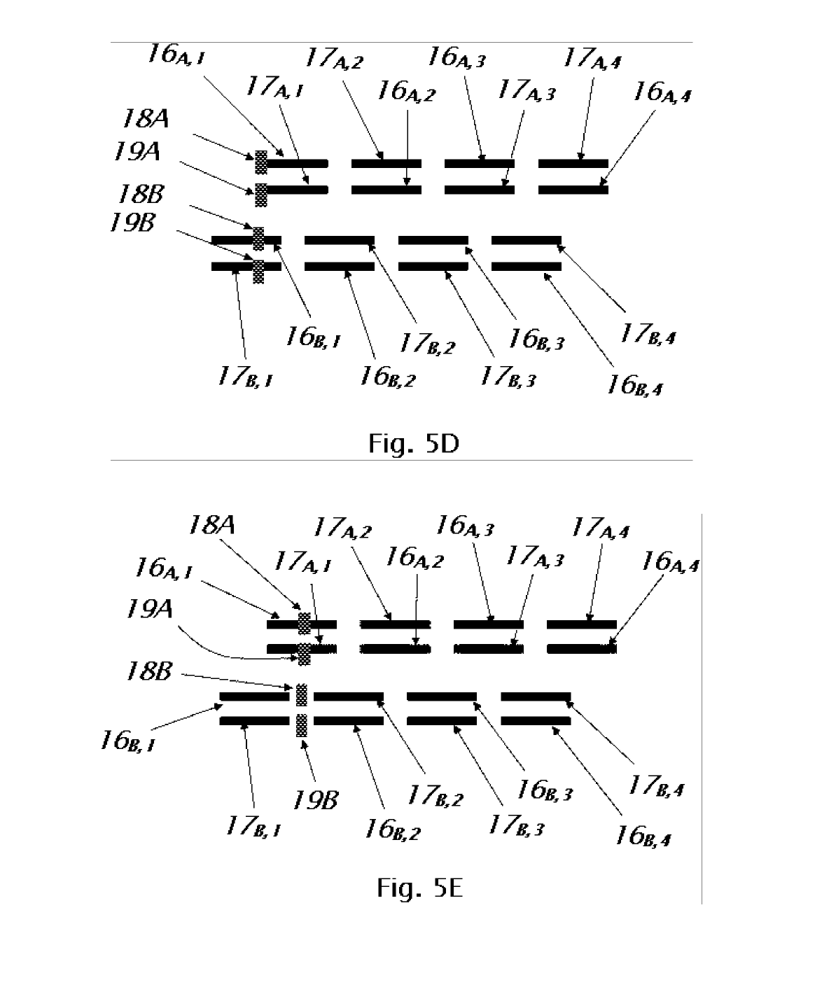

FIGS. 5A to 5C show a conceptual model that the actuator can move much longer. FIG. 5A shows the polarities of the printed coils and/or the magnets of three corresponding rows, one from each of the two stators and the actuator, as an example. Assume that the stators are composed of printed coils and the controller changes the polarities of the printed coils of the stators to control the movement of the actuator. The polarities of the printed coils or magnets of each row of the actuator 44 and the stators 42A and 42B are alternating. Each printed coil 52ᵢ of the stator 42A is aligned with the boundary of the consecutive printed coils 56ᵢ₋₁ and 56ᵢ of the stator 42B. As shown in FIG. 5A, each printed coil or magnet 54ⱼ of the actuator 44 is aligned with and has the opposite polarity with a printed coil 52ᵢ of the stator 42A. The actuator 44 does not receive lateral force from the stator 42A. Each printed coil or magnet 54ⱼ of the actuator 44 is also aligned with the boundary of the consecutive printed coils 56ᵢ₋₁ and 56ᵢ of the stator 42B. So, each printed coil or magnet 54ⱼ of the actuator 44 has the same polarity with the printed coils 56ᵢ₋₁ and has the opposite polarity with the printed coils 56ᵢ. Hence, it is pulled to the right by the printed coil 56ᵢ₋₁ and is pushed to the right by the printed coil 56ᵢ. The force from other printed coils is much smaller. So, the actuator 44 receives the electromagnetic force to move to the right. As soon as each printed coil of the stator 42A is no longer aligned with the printed coil or the magnet of the actuator 44, each printed coil or magnet 54ⱼ of the actuator 44 is pulled to the right by the printed coil 52ᵢ₋₁, pushed to the right by the printed coil 52ᵢ, and pulled to the left by the printed coil 52ᵢ₊₁ of the stator 42A. The force from other printed coils is much smaller. The net force is to the right. So, the actuator 44 receives net force to move to the right. When the actuator 44 moves to where each printed coil or magnet of the actuator 44 is aligned with a printed coil of the stator 42B as shown in FIG. 5B, the polarities of the printed coils of the stator 42B are reversed as FIG. 5C shows. Similar with the above, the actuator 44 does not receive lateral force from the stator 42B. Each printed coil or magnet 54ⱼ of the actuator 44 is pulled to the right by the printed coil 52ᵢ₋₁ and is pushed to the right by the printed coil 52ᵢ of the stator 42A. So, the actuator 44 continues to move to the right. As soon as the printed coils or the magnets of the actuator 44 are no longer aligned with the printed coils of the stator 42B, each printed coil or magnet 54ⱼ of the actuator 44 is pulled to the right by the printed coil 56ᵢ₋₂, pushed to the right by the printed coil 56ᵢ₋₁, and pulled to the left by the printed coil 56ᵢ of the stator 42B. So, the actuator 44 receives net force to move to the right. The above process repeats so that the actuator 44 continues to move to the right. Reversing the polarities of the printed coils of the stators, the actuator 44 to moves in reverse direction with the reverse process.

For the above model, determining when the printed coils or the magnets of the actuator 44 are aligned with the printed coils of the stators 42A and 42B is essential. So that the controller may change the current polarities of the printed coils of the stators 42A and 42B at the right moments of time. In FIGS. 5A to 5C, there are a number of stator contacts 14 on the stator 42A or 42B, on the substrate, or on the case. There are also a number of actuator contacts 15 on the actuator 44. When the actuator 44 moves to where the printed coils or the magnets of the actuator 44 are aligned with the printed coils of the stator 42A or the stator 42B, at least one actuator contact 15 and at least one stator contact 14 are contacted. So, detecting which actuator contact 15 and which stator contact 14 are short circuit, the controller can determine which stator need to change the polarities of the printed coils. So, the actuator 44 continues to move while the controller continues to change the polarities of the printed coils of the stators 42A and 42B at the right moments of time. The actuator 44 moves half of the distance between two consecutive printed coils each time the printed coils or the magnets of the actuator 44 are aligned with the printed coils of either the stator 42A or the stator 42B. That can be a step of the step motor. So, the actuator of this motor can move step by step where each step is a fixed length.

FIGS. 5D and 5E show another example of the mechanism to change the polarities of the printed coils of the stators 42A and 42B when the printed coils or magnets of the actuator 44 are aligned with the printed coils of the stators 42A and 42B, respectively. The stator 42A has a number of coil contacts 16_{A,i} and 17_{A,j} for some i and j. All coil contacts 16_{A,i} are connected to one terminal of the connected windings of the stator 42A and all coil contacts 17_{A,i} are connected to the other terminal of the connected windings of the stator 42A. The coil contacts 16_{A,i} and the coil contacts 17_{A,j} form a line in parallel with the moving direction for all odd number i and for all even number j. The coil contacts 16_{A,i} and the coil contacts 17_{A,j} form another line in parallel with the moving direction for all even number i and for all odd number j. Similarly, the stator 42B has a number of coil contacts 16_{B,i} and 17_{B,j} for some i and j. All coil contacts 16_{B,i} are connected to one terminal of the connected windings of the stator 42B and all coil contacts 17_{B,i} are connected to the other terminal. The coil contacts 16_{B,i} and the coil contacts 17_{B,j} form a line in parallel with the moving direction for all odd number i and for all even number j. The coil contacts 16_{B,i} and the coil contacts 17_{B,j} form another line in parallel with the moving direction for all even number i and for all odd number j. The actuator 44 has two power contacts 18A and 19A for the stator 42A and two power contacts 18B and 19B for the stator 42B that are connected to the power supply. The power contacts 18A and 19A have opposite electrical polarities and so do the power contacts 18B and 19B. The FIGS. 5D and 5E show the projections of the coil contacts and the power contacts on the substrate only. Also, to show the timing, the projections for the stator 42A is shown on the top and the projections for the stator 42B is shown on the bottom of the figures. FIG. 5D corresponds to FIG. 5A where the power contacts 18A and 19A connect to the coil contacts 16_{A,1} and 17_{A,1}, respectively, and the power contacts 18B and 19B connect to the coil contacts 16_{B,1} and 17_{B,1}, respectively. Hence, the stators 42A and 42B have polarities shown in FIG. 5A. As the actuator 44 moves to the right, the power contacts 18B and 19B will disconnect from the coil contacts 16_{B,1} and 17_{B,1}, respectively, as FIG. 5E shows. The electrical current applied to the printed coils of the stator 42B is stopped. Meanwhile, the printed coils of the stator 42A are still connected to the power source. As the actuator 44 continues to move to the right, the power contacts 18B and 19B connect to the coil contacts 17_{B,2} and 16_{B,2}, respectively. The printed coils of the stator 42B are connected to the power source and the polarities are changed as shown in FIG. 5C. This process continues until the controller stops applying the current to all printed coils or the actuator moves to out of the range stated above. To drive the actuator to move in the reverse direction, the electrical polarities of the power contacts 18A, 19A, 18B, and 19B are reversed.

Another solution is to install the light emitters and the detectors. Either the emitters or the detectors are stationary and the other move along with the actuator. Alternatively, in addition to the emitters and the detectors, light reflectors are installed. Either the emitters and the detectors are stationary and the reflectors move with the actuator or the reflectors are stationary and the emitters and the detectors move with the actuator. When the printed coils need to change the polarities, a detector detects the light. The controller acknowledges it and changes the polarity of the electrical current applied to the corresponding printed coils.

An alternative model is that the two stators and the actuator comprise printed coils whose polarities are changeable. When each printed coil of the actuator 44 is aligned with a printed coil of a stator, the polarities of the printed coils of the actuator 44 and the other stator are reversed. It works similarly with the above model.

The model shown in FIGS. 5A to 5C has another alternative where the actuator comprises rows of printed coils with changeable polarities and the stators comprise rows of printed coils or magnets with fixed polarities. The leading edge of each printed coil of the actuator is aligned with two printed coils or magnets of the two stators, respectively, having the same polarity. Then, the actuator moves back and forth when the printed coils of the actuator are changed polarities. So, the model shown in FIGS. 4A to 4D is a special case of this model where each printed coil or magnet of one stator is aligned with and has the same polarity with the corresponding printed coil or magnet of the other stator.

If the model shown in FIGS. 5A to 5C and its alternatives have only one stator, they are the same with the model shown in FIGS. 4A to 4D.

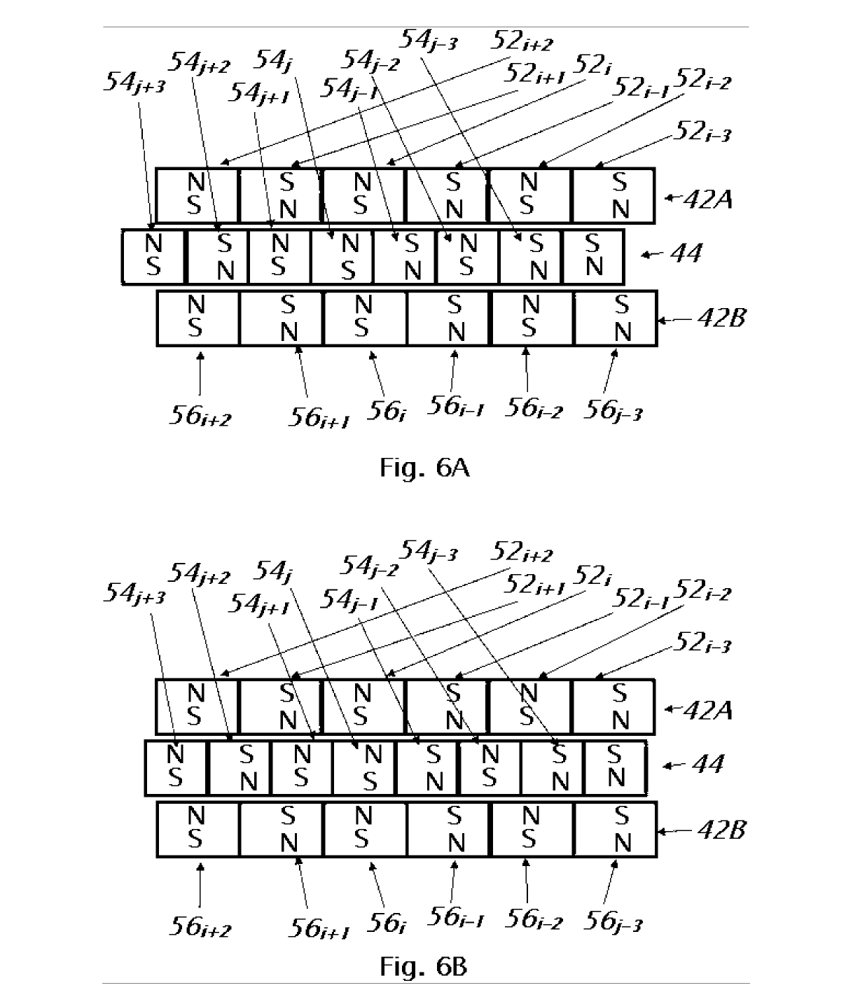

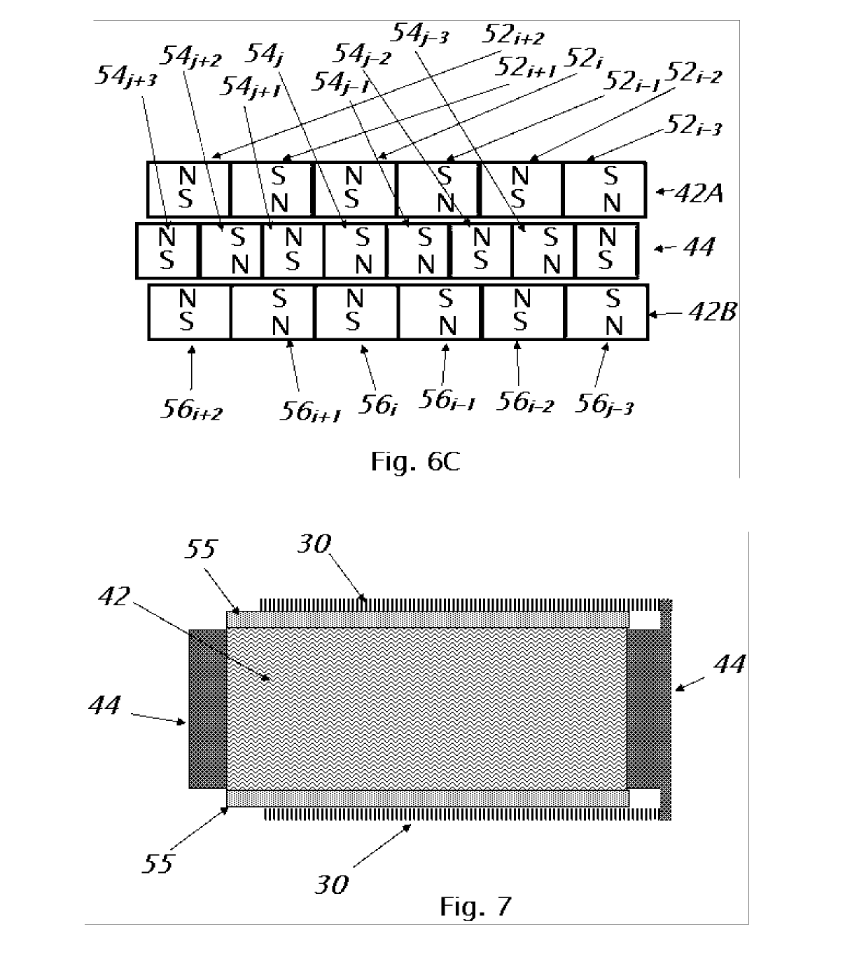

The side view of the stators 42A and 42B and the actuator 44 of another conceptual model of linear motor is shown in FIGS. 6A to 6C. Assume that both stators 42A and 42B comprise printed coils or magnets that have fixed and alternating polarities. The actuator 44 comprises printed coils that have changeable polarities. The distance between two consecutive printed coils or magnets of the stators 42A and 42B is longer than that of the actuator 44. As shown in FIG. 6A, the polarities of the printed coils of the actuator 44 are alternating except the pair of printed coils 54ⱼ₊₁ and 54ⱼ and the pair of printed coils 54ⱼ₋₄ and 54ⱼ₋₃. The printed coil 54ⱼ₊₁ is aligned with the printed coils or magnets 52ᵢ₊₁ and 56ᵢ₊₁ of the stators 42A and 42B, respectively, and the printed coil 54ⱼ₋₃ is aligned with the printed coils or magnets 52ᵢ₋₂ and 56ᵢ₋₂ of the stators 42A and 42B, respectively. The printed coil 54ⱼ₊ₓ of the actuator 44 is pulled to the right by the printed coils or magnets 52ᵢ₊ₓ₋₁ and 56ᵢ₊ₓ₋₁ of the stators 42A and 42B, respectively, and is pushed to the right by the printed coils or magnets 52ᵢ₊ₓ and 56ᵢ₊ₓ of the stators 42A and 42B, respectively, where 1<x. The printed coil 54ⱼ₊ₓ of the actuator 44 is pulled to the right by the printed coils or magnets 52ᵢ₊ₓ and 56ᵢ₊ₓ of the stators 42A and 42B, respectively, and is pushed to the right by the printed coils or magnets 52ᵢ₊ₓ₊₁ and 56ᵢ₊ₓ₊₁ of the stators 42A and 42B, respectively, where x<=0. The exception is that the leftmost printed coil 54ⱼ₊₃ of the actuator 44 does not have the printed coils or magnets 52ᵢ₊₃ and 56ᵢ₊₃ to push to the right. So, the actuator 44 receives a net electromagnetic force to move to the right. When the actuator 44 moves to where the printed coils 54ⱼ and 54ⱼ₋₄ are aligned with the printed coils or magnets 52ᵢ and 52ᵢ₋₃, respectively, as shown in FIG. 6B, the polarities of the printed coils 54ⱼ and 54ⱼ₋₄ are changed as shown in FIG. 6C. Then, it is equivalent to that depicted in FIG. 6A. The process repeats. So, the actuator 44 continues to move to the right. The mechanism to determine when which printed coils should change the polarity is similar with the above models. Reversing the polarities of the printed coils of the actuator 44 will make the actuator 44 move in the reverse direction.

The model that the actuator 44 comprises printed coils or magnets that have fixed and alternating polarities and both stators 42A and 42B comprise printed coils that have changeable polarities works similarly. Also, for these two models, there may be only one stator.

Let m be the distance between two consecutive printed coils or magnets of either the stators or the actuator whose polarities are fixed and n be the that between two consecutive printed coils of the other whose polarities are changeable. Then, the model shown in FIGS. 6A to 6C is an example for the case m>n. The number of printed coils that change the polarities at the same time is the greatest common factor of m and n. For the special case where m=2n, half of the printed coils change the polarities at the same time. The model shown in FIGS. 4C to 4D is an example for the case m=n. For the case m<n<2m, there are printed coils with changeable polarities whose leading and tailing edges are aligned with the printed coils or magnets with the same polarities. This reduces the efficiency. In general, as n increases, the efficiency will get worse if m<n. If n>=2m, this model will not work.

All above models of linear motor have a common variation that the actuator 44 connects or attaches to the spring or elastic device 30 as shown in FIG. 7. The actuator 44 is at the default position when the electrical current is not applied to the printed coils of the stators 42A and 42B and the actuator 44. The actuator 44 moves to the desired position when the electrical current is applied to the printed coils of the stators 42A and 42B or to the actuator 44 or both. That also squishes or stretches the spring or elastic device 30. The actuator 44 is pushed or pulled back to the default position by the spring or elastic device 30 when the electrical current stops.

Each of the above models has a dual rotary motor where the arrays of printed coils and/or magnets of the stators and the actuator are wrapped to be concentric rings of printed coils and/or magnets. The dual of the model shown in FIGS. 4A to 4D is obvious. Either the stators or the actuator comprises printed coils whose polarities can be changed to control the movement of the actuator. There may be only one stator. The actuator rotates back and forth. The figures are not shown.

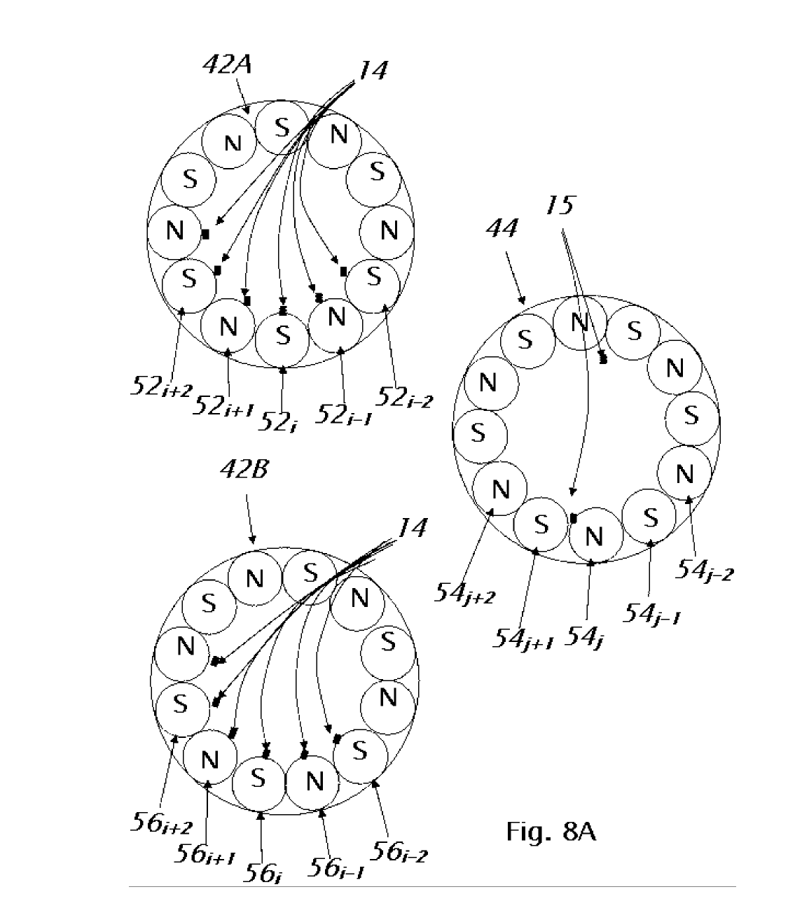

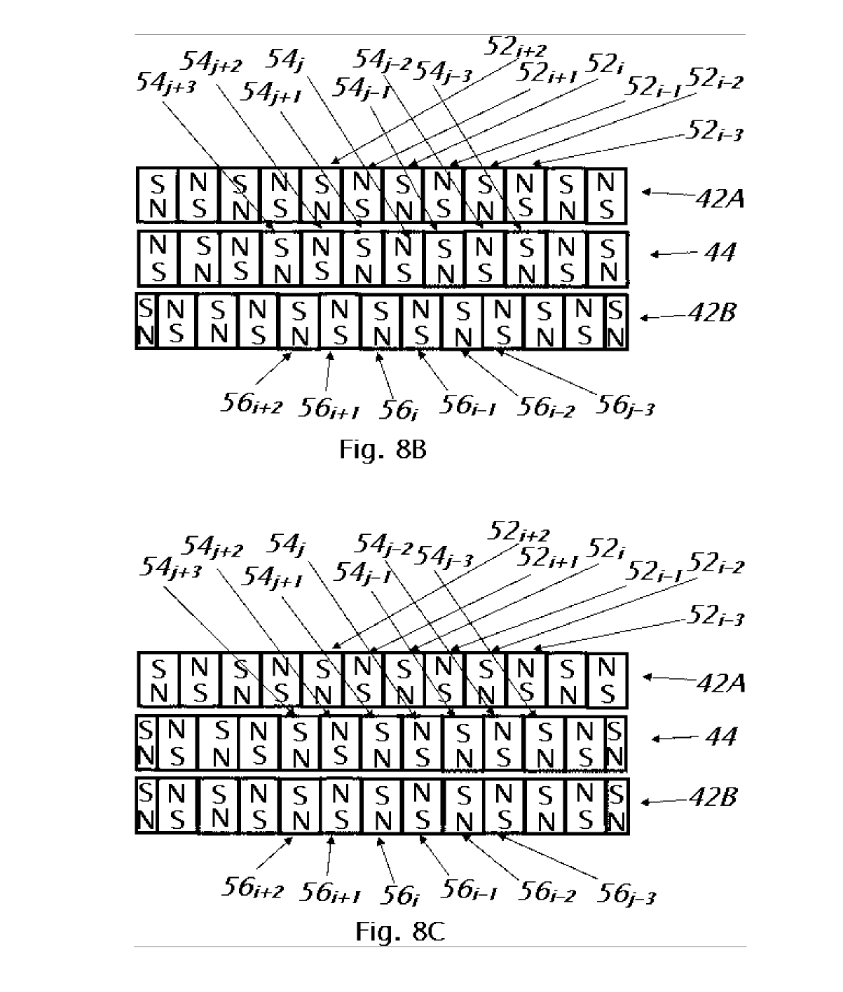

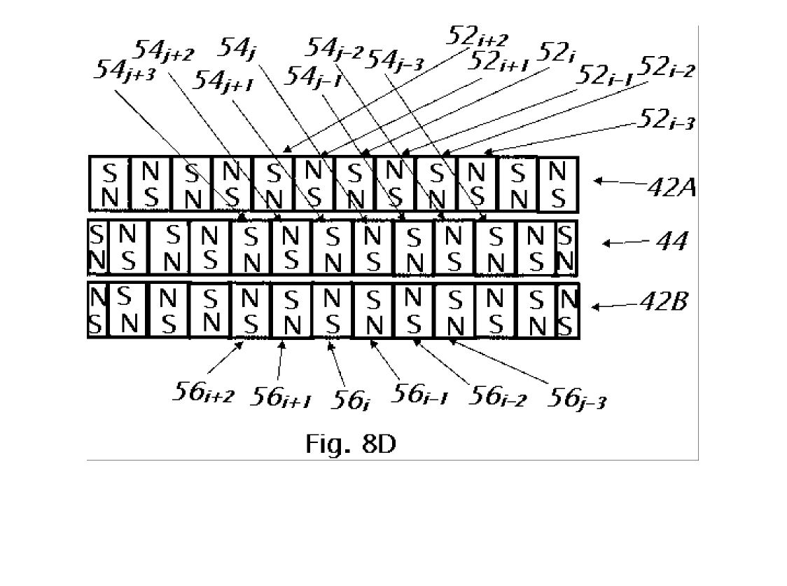

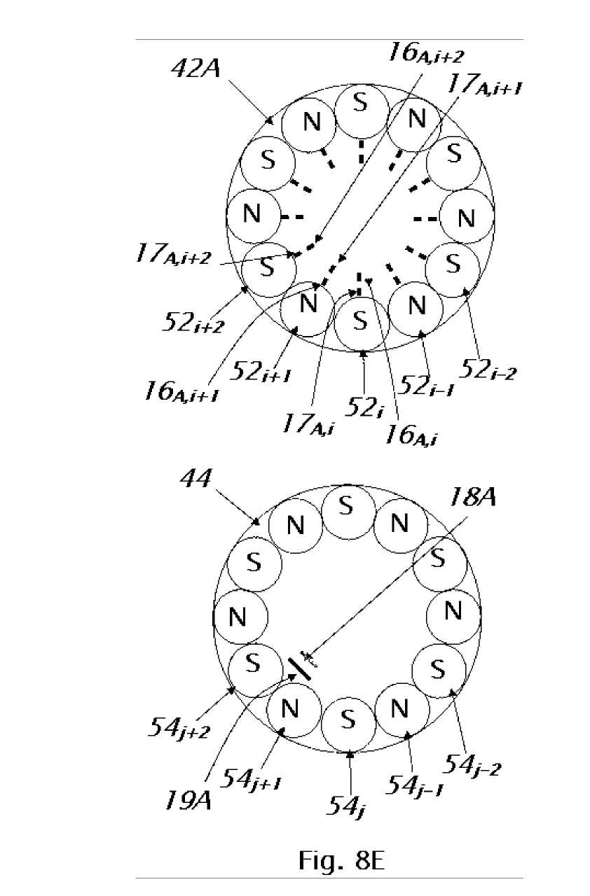

The dual of the model shown in FIGS. 5A to 5C is shown in FIGS. 8A to 8D. FIG. 8A shows the top views of the two stators and the actuator and their electromagnetic polarities. The axle is not shown in the figures to keep them neat. The actuator 44 rotates between the two stators 42A and 42B. The two stators 42A and 42B and the actuator 44 may have any but the same number of concentric rings of printed coils or magnets. The number of printed coils or magnets in a ring of the actuator 44 is the same as that of the corresponding rings of the two stators 42A and 42B. This example assumes that the two stators 42A and 42B comprise rings of printed coils so that the magnetic polarities can be changed. The polarities of the magnets or printed coils of the actuator 44 are fixed when the actuator 44 rotates. FIGS. 8B to 8D show the side view of the stators 42A and 42B and the actuator 44 where the rings spread to be linear. As shown in FIGS. 8A and 8B, each printed coil of the stator 42A is aligned with and has the opposite polarity with a printed coil or magnet of the actuator 44. The stator 42A does not apply the lateral electromagnetic force to the actuator 44. Each printed coil or magnet 54ⱼ of the actuator 44 is aligned with the boundary of the consecutive printed coils 56ᵢ₋₁ and 56ᵢ of the stator 42B. It has the same polarity with the printed coil 56ᵢ₋₁ and has the opposite polarity with the printed coil 56ᵢ. So, it is pulled to the right by the printed coil 56ᵢ₋₁ and is pushed to the right by the printed coil 56ₗ of the stator 42B. So, the actuator 44 rotates counter-clockwise. As soon as each printed coil of the stator 42A is no longer aligned with the printed coil or magnet of the actuator 44, each printed coil or magnet 54ⱼ of the actuator 44 is pulled to the right by the printed coil 52ᵢ₋₁, pushed to the right by the printed coil 52ᵢ, and pulled to the left by the printed coil 52ᵢ₊₁ of the stator 42A. The net force is to the right. When the actuator 44 rotates to where each printed coil or magnet of the actuator 44 is aligned with a printed coil of the stator 42B as shown in FIG. 8C, the polarities of the printed coils of the stator 42B are reversed as FIG. 8D shows. It is equivalent to that shown in FIG. 8B. So, the actuator 44 continues to rotate counter-clockwise. The above process repeats so that the actuator 44 continues to rotate.

The model that the two stators and the actuator comprise printed coils whose polarities are changeable works similarly. When each printed coil of the actuator 44 is aligned with a printed coil of a stator, the polarities of the printed coils of the actuator 44 and the other stator are reversed.

The mechanisms to determine when the printed coils or magnets of the actuator 44 are aligned with the printed coils of the stators 42A and 42B are similar with that of the linear motor model above. FIG. 8A also shows an example of the first one. There are a number of stator contacts 14 that do not move. There are also a number of actuator contacts 15 that move along with the actuator 44. When the actuator 44 rotates to where the printed coils or magnets of actuator 44 are aligned with the printed coils of the stator 42A or the stator 42B, at least one actuator contact 15 and at least one stator contact 14 are contacted. So, detecting which actuator contact 15 contacts which stator contacts 14, the controller can determine which printed coils need to change the polarities. So, the actuator 44 continues to rotate while the controller continues to change the polarities of the printed coils of the stators 42A and 42B at the right moments of time. This model can be a step motor where the controller counts the number of times when the printed coils or the magnets of the actuator 44 are aligned with the printed coils of either the stator 42A or the stator 42B.

FIG. 8E shows the circle version of the mechanism to change the polarities of the printed coils shown in FIGS. 5D and 5E where only the coil contacts on the stator 42A and the power contacts on the actuator 44 are shown. The same mechanism is applied to the stator 42B and the actuator 44. In general, the stator 42A has a number of coil contacts 16_{A,i} and 17_{A,i} for some i. All coil contacts 16_{A,i} are connected to one terminal of the connected windings of the stator 42A and all coil contacts 17_{A,i} are connected to the other terminal of the connected windings of the stator 42A. The coil contacts 16_{A,i} and the coil contacts 17_{A,j} form a ring for all i and j where i is an odd number and j is an even number. The coil contacts 16_{A,i} and the coil contacts 17_{A,j} form another ring for all i and j where i is an even number and j is an odd number. The actuator 44 has two power contacts 18A and 19A for the stator 42A that are connected to the power supply, respectively. The power contacts 18A and 19A have opposite electrical polarities. When the printed coils or magnets of the actuator 44 are not aligned with the printed coils of the stator 42A, a pair of the coil contacts 16_{A,i} and 17_{A,i} are contacted with the power contacts 18A and 19A, respectively. The printed coils of the stator 42A generate the electromagnetic force to drive the actuator 44 as explained above. As the actuator 44 rotates, The actuator 44 will rotate to where the printed coils or magnets of the actuator 44 are aligned with the printed coils of the stator 42A. Then, the power contacts 18A and 19A disconnect from the coil contacts 16_{A,i} and 17_{A,i}, respectively, and connect to the coil contacts 16_{A,i-1} and 17_{A,i-1}, respectively. So that the printed coils of the stator 42A change the polarities. Exact mechanism is applied to the stator 42B. This process continues until the controller stops applying the electrical current to the printed coils. To be a step motor, the controller detects the number of times that the coil contacts change polarities. Each time the printed coils of either stator change the electromagnetic polarities can be a step of the actuator. The controller stops the electrical current applied to the printed coils when the actuator rotates enough steps.

The circular version of the optical polarity changing means is similar. Either the emitters or the detectors are stationary and the other rotate with the actuator. Alternatively, either the emitters and the detectors are stationary and the reflectors rotate with the actuator or the reflectors are stationary and the emitters and the detectors rotate with the actuator. When the printed coils need to change the polarities, a detector detects the light. The controller acknowledges it and changes the polarity of the electrical current applied to the printed coils.

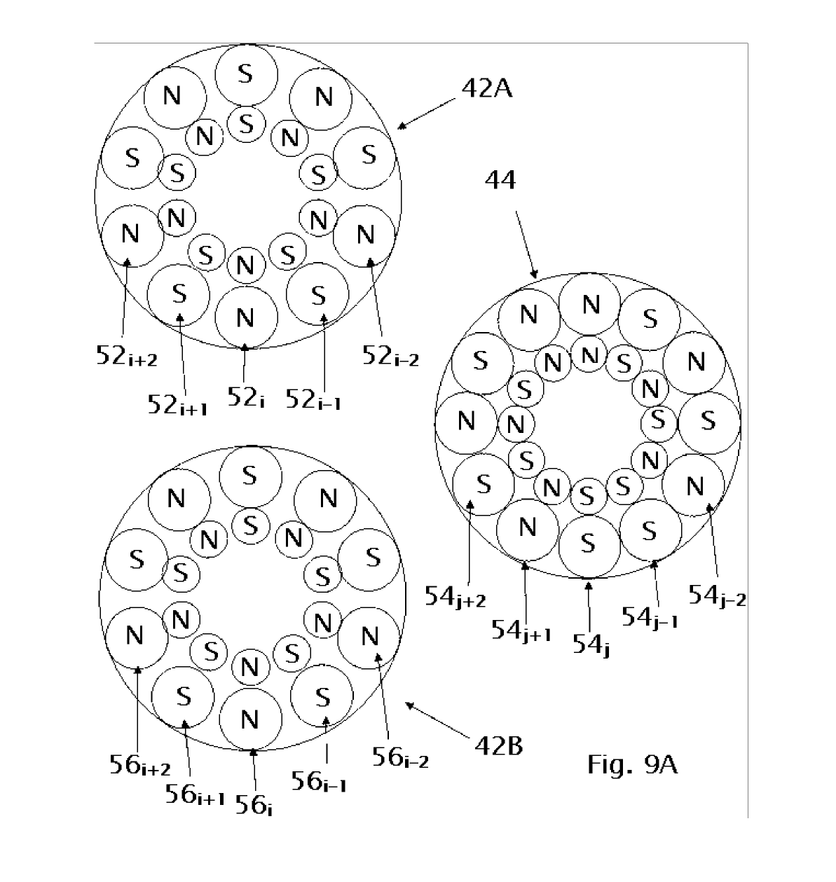

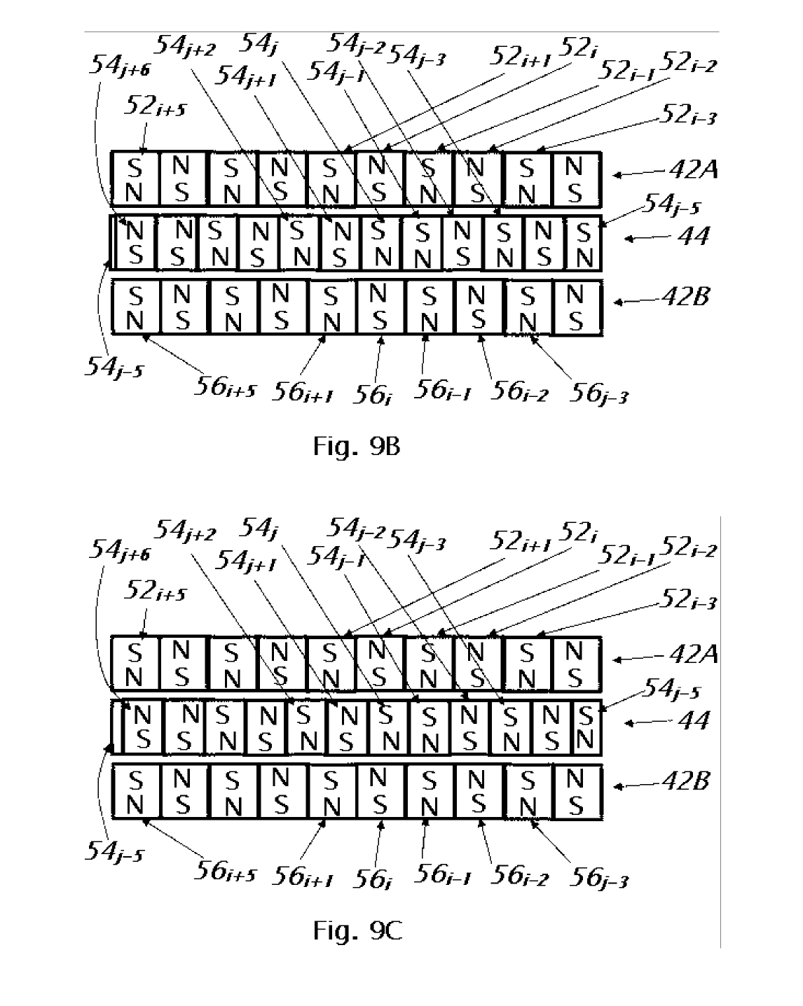

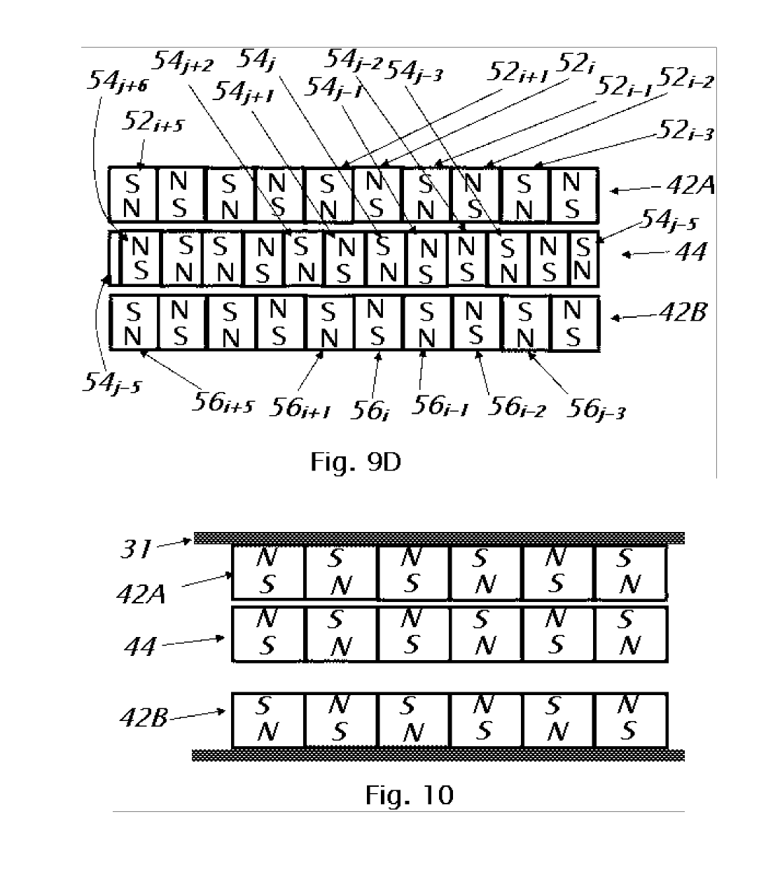

The top views of the two stators and the actuator of the dual of the model shown in FIGS. 6A to 6C is shown in FIG. 9A where two rings are assumed. The side views of the explanation are shown in FIGS. 9B to 9D where the printed coils and/or magnets are spreaded to be linear for explanation. The axle is not shown in the figures to keep them neat. The stators 42A and 42B and the actuator 44 may have any but the same number of concentric rings of printed coils or magnets. Assume that both stators 42A and 42B comprise printed coils or magnets that have fixed and alternating polarities. The actuator 44 comprises printed coils that have changeable polarities. The distance between two consecutive printed coils or magnets of the stators 42A and 42B is longer than that of the actuator 44. As shown in FIG. 9B, the polarities of the printed coils of the actuator 44 are alternating except the pair of printed coils 54ⱼ₊₆ and 54ⱼ₊₅ and the pair of printed coils 54ⱼ and 54ⱼ₋₁. The printed coil 54ⱼ₊₆ is aligned with and has the opposite polarity with the printed coils or magnets 52ᵢ₊₅ and 56ᵢ₊₅ of the stators 42A and 42B, respectively, and the printed coil 54ⱼ is aligned with and has the opposite polarity with the printed coils or magnets 52ᵢ and 56ᵢ of the stators 42A and 42B, respectively. The printed coil 54ⱼ₊ₓ is pulled counter-clockwise by the printed coils or magnets 52ᵢ₊ₓ₋₁ and 56ᵢ₊ₓ₋₁ and is pushed counter-clockwise by the printed coils or magnets 52ᵢ₊ₓ and 56ᵢ₊ₓ where 0<x<6. The printed coil 54_{j-y} is pulled counter-clockwise by the printed coils or magnets 52_{i-y} and 56_{i-y} and is pushed counter-clockwise by the printed coils or magnets 52_{i-y+1} and 56_{i-y+1} where 0<y<6. So, the actuator 44 rotates counter-clockwise. As soon as the printed coils 54ⱼ₊₆ and 54ⱼ are no longer aligned with the printed coils or magnets 52ᵢ₊₅ and 52ᵢ, respectively, the printed coils 54ⱼ₊₆ is pulled counter-clockwise by the printed coils or magnets 52ᵢ₊₄ and 56ᵢ₊₄, pushed counter-clockwise by the printed coils or magnets 52ᵢ₊₅ and 56ᵢ₊₅, and is pulled clockwise by the printed coils or magnets 52ᵢ₋₄ and 56ᵢ₋₄. The net force is counter-clockwise. Also, the printed coils 54ⱼ is pulled counter-clockwise by the printed coils or magnets 52ᵢ₋₁ and 56ᵢ₋₁, pushed counter-clockwise by the printed coils or magnets 52ᵢ and 56ᵢ, and is pulled clockwise by the printed coils or magnets 52ᵢ₊₁ and 56ᵢ₊₁. The net force is counter-clockwise, too. When the actuator 44 rotates to where the printed coils 54ⱼ₊₅ and 54ⱼ₋₁ are aligned with the printed coils or magnets 52ᵢ₊₄ and 52ᵢ₋₁, respectively, as shown in FIG. 9C, the polarities of the printed coils 54ⱼ₊₅ and 54ⱼ₋₁ are changed to be the opposites of the printed coils or magnets 52ᵢ₊₄ and 52ᵢ₋₁, respectively, as shown in FIG. 9D. Then, it is equivalent to that depicted in FIG. 9B. The process repeats. So, the actuator 44 continues to rotate counter-clockwise. The mechanism to determine when which printed coils should change the polarity is similar with the above models.

This model also has an alternative that the actuator 44 comprises printed coils or magnets that have fixed and alternating polarities and both stators 42A and 42B comprise printed coils that have changeable polarities. It works similarly. Also, for these two models, there may be only one stator.

FIG. 10 shows the vertical cross section view of the conceptual model of a thin electromagnetic driver that uses printed coils and/or magnets. The polarities of the magnets and the printed coils are perpendicular with the plan of the substrate or the case 31. Each printed coil or magnet of the stator 42A is aligned with and has opposite polarity with the corresponding one of the stator 42B. Each printed coil or magnet of the actuator 44 is aligned with the corresponding one of each of the stators 42A and 42B. So, the actuator 44 is controlled by applying the electrical current to the printed coils of the actuator 44 or to the printed coils of the stators 42A and 42B. It is pulled by one of the stators and is pushed by the other. There may be only one stator. The actuator may be connected to a spring so that the actuator is at the default position when the electrical current is not applied and is driven to another position when the electrical current is applied. The actuator may be simplified to be a piece of metal and there is only one stator that comprises printed coils.

The printed coils are thin. So, all motors and driver above are thin. The polarities of the printed coils are perpendicular with the plan of the case and the substrate. However, some applications may need the printed coils whose polarities are parallel with the plan of the case and the substrate. The following explains the conceptual models where the polarities of the printed coils and magnets are parallel with the plan of the motor or the driver and the printed coils are cascaded to have stronger magnetism.

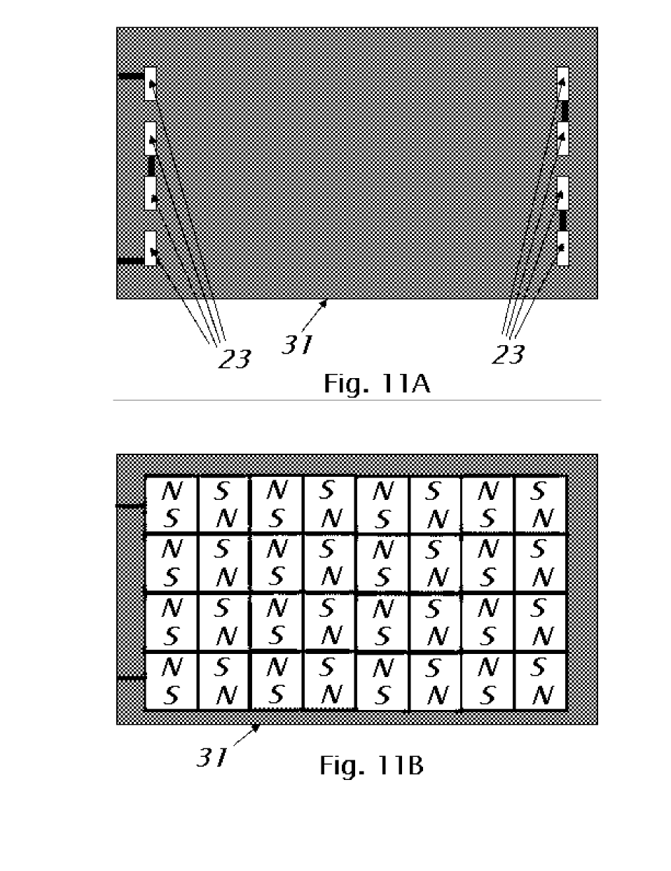

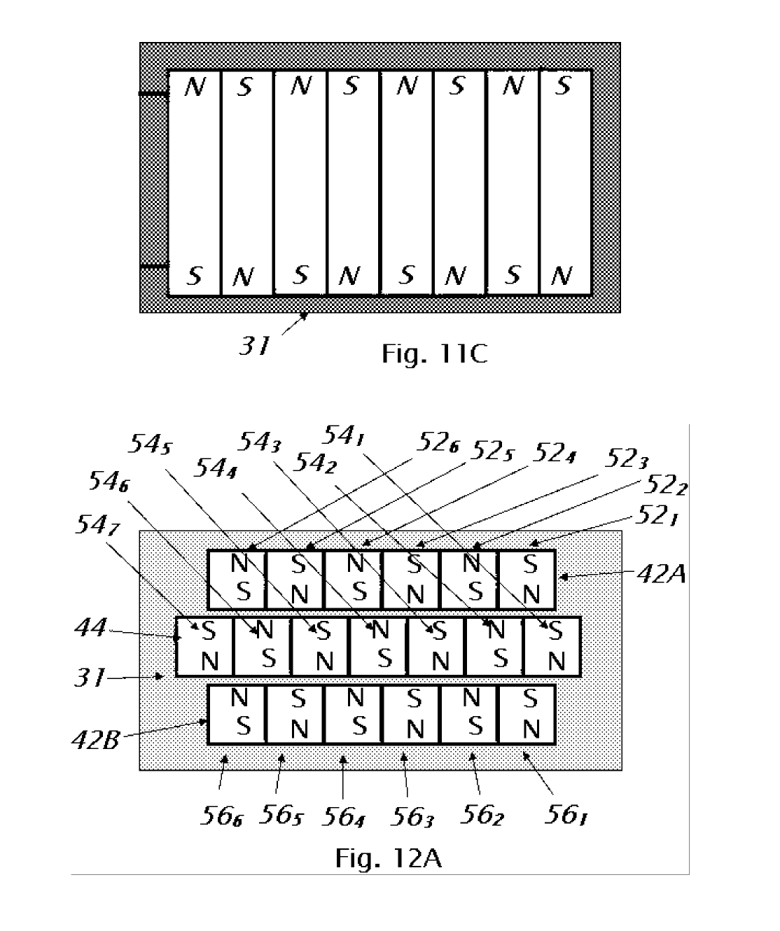

FIGS. 11A to 11C show that, using the printed coil array depicted in FIGS. 1A to 1D, one-dimensional array of printed coils are made so that the polarities are parallel with the plan of the substrate 31. In this example, four rows of one-dimensional arrays of eight-printed coil are cascaded. The eight-printed coil array has a pair of terminal perimeters 11A and 11B on the two ends of each one-dimensional array. Cut the four arrays so that the terminal perimeters 11A and 11B are cut through on the cutting line. FIG. 11A shows the substrate 31 and the connecting points 23. Assume that the four arrays of printed coils are connected in series. The relative positions of the connecting points 23 on the substrate are the same as the power points 11A and 11B of the four arrays when the arrays of printed coils are cascaded together. Therefore, the four arrays can be laterally installed on the substrate where the terminal perimeters 11A and 11B of the arrays are soldered to the corresponding connecting points 23 on the substrate as shown in FIG. 11B. Although there are only four rows in FIG. 11B, any number of rows of printed coils can be cascaded. Since the polarity of the printed coils in the same column is the same and is parallel with the substrate, each column is equivalent to a single printed coil as FIG. 11C shows. The thickness of the resulting array is proportional to the size of the windings on the PCB. The length of a printed coil is the summation of the thickness of the PCB in the same column. The flux of the resulted printed coil is approximately the summation of the flux generated by the windings in the same column. Although the arrays are connected in series in this example, the arrays of printed coils can be connected in parallel if each series has appropriate impedance.

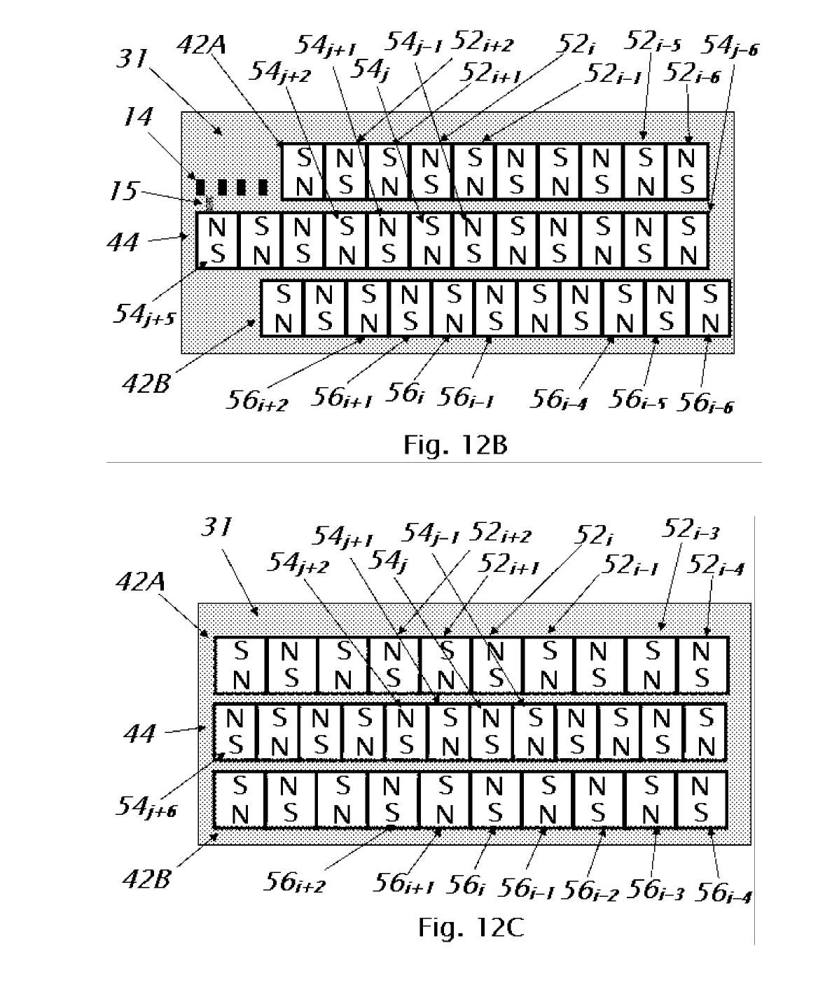

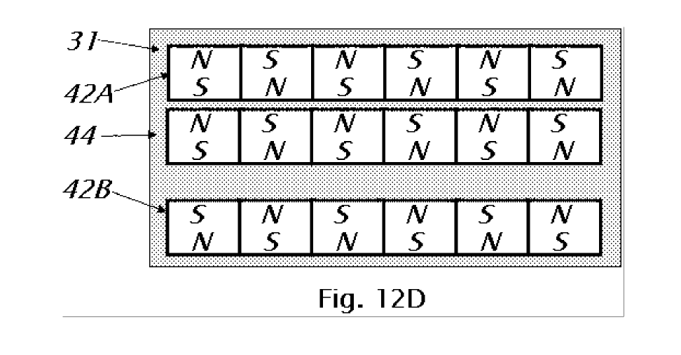

FIGS. 12A to 12D show the conceptual models similar with those explained in FIGS. 4A to 4D, 5A to 5C, 6A to 6C, and 10, respectively, where the polarities of the printed coils are parallel with the plan of the substrate 31. Each of them also has the variation that the actuator is connected to or attached to a spring. The models shown in FIGS. 12A, 12C, and 12D, respectively, may have only one stator. They all work similarly.

### CONCLUSION

Accordingly, the readers can see that variant models of linear, rotary and step motors and the electromagnetic drivers disclosed in this invention are thin as the printed coil PCB is thin. They are flexible if the printed coil PCBs or the coil PCBs and the magnet boards are flexible. The printed coils are made of PCB with minimum number of vias. The apparatuses using the thin motors or drivers can be thin, too. They are ideal to be used under the user's clothes or be attached to the user's skin. The user will feel much more comfortable to use them.

Although the description above contains many specifications, these should not be constructed as limiting the scope of the invention but as merely providing illustrations of some of the presently preferred embodiments of this invention. Thus the scope of the invention should be determined by the appended claims and their legal equivalents, rather than by the examples given.

What is claimed is:

1. The windings of a set of printed coils on a PCB that are operated and whose electromagnetic polarities are changed at the same time are wired as follows:
the centers of all windings of the same printed coil are aligned and every two adjacent centers are connected with a buried via to have the same wiring direction where one of two said windings is wired from the perimeter to the center and the other is from the center to the perimeter; the perimeters of every two windings on the same layer are connected with a path to have desired wiring direction and there may be few exceptions for convenience to connect to different layers; the connected windings in different layers are connected in series by connecting their terminal perimeters with vias and paths to form connected windings
so that all windings of all coils on all layers in the set are connected without forming any loops; the electromagnetic polarities of all windings of each printed coil is the same and the relative polarities of all printed coils in the set are as desired when electrical current is applied to the two terminal perimeters of the connected windings; and the polarity of each printed coil is reversed when the polarity of the electrical current applied to the two terminal perimeters is reversed.

2. A thin printed electromagnetic driving device comprising:
a thin housing;
one or two thin stators fixed in said housing where each said stator comprises either a multi-layered coil PCB that further comprises lines of connected and evenly distributed printed coils or a thin magnet board that further comprises lines of evenly distributed thin magnets;
a thin actuator moveable in parallel with said stator(s) comprising either a multi-layered coil PCB that further comprises lines of connected and evenly distributed printed coils or a thin magnet board that further comprises lines of evenly distributed thin magnets but not the magnet board if said stator(s) comprises the magnet board;
a guiding means in said housing to regulate the moving of said actuator; and
a controller controlling the electrical current with appropriate polarities applied to all printed coils of said stators and said actuator at the desired moments of time;
where the polarities of the printed coils and the magnets of said stator(s) and said actuator are either perpendicular with or parallel with said housing;
each line of printed coils or magnets of said actuator is aligned with the corresponding line(s) of printed coils or magnets of said stator(s); and
either said stator(s) or said actuator has printed coils or magnets with fixed and alternating electromagnetic polarities in each line and the other have/has printed coils with changeable polarities by changing the directions of the electrical current applied to the printed coils during the operation
so that said controller applies the electrical current to the printed coils of said actuator and/or said stator(s) with appropriate polarities during the operation to control the movement of said actuator;
when the leading and the tailing edges of a printed coil of said stator(s) are aligned with two consecutive, the first and the second, printed coils or magnets of said actuator, respectively, said printed coil of said stator(s) has the same polarity with said second printed coil or magnet and has the opposite polarity with said first printed coil or magnet if said stator(s) comprises printed coils;
when the leading and the tailing edges of a printed coil of said actuator are aligned with two consecutive, the first and the second, printed coils or magnets of said stator(s), respectively, said printed coil of said actuator has the same polarity with said first printed coil or magnet and has the opposite polarity with said second printed coil or magnet if said actuator comprises printed coils; hence,
said actuator receives net electromagnetic force from said stator(s) to move in the desired direction that is regulated by said guiding means; and
said controller activates and stops said actuator by applying and stopping, respectively, the electrical current to the printed coils of said actuator and said stator(s).

3. The closure of claim 2 wherein said actuator is connected to or attached to an elastic device
so that said actuator is at a default position when there is not electrical current applied to the printed coils of said stator(s) and said actuator and is moved to another position when electrical current is applied to the printed coils of said stator(s) and said actuator.

4. The closure of claim 2 wherein
said driving device is a linear motor;
said lines of printed coils or lines of magnets of said stator(s) are straight rows of printed coils or magnets that have fixed and alternating polarities during the operation;
each printed coil or magnet of one of said stators is aligned with and has the same polarity with the corresponding one of the other said stator when there are two said stators;
said lines of printed coils or lines of magnets of said actuator are straight rows of printed coils that have changeable and alternating polarities during the operation;
the distance between the centers of two consecutive printed coils in a row of said actuator equals that between the centers of two consecutive printed coils or magnets in the aligned row(s) of said stator(s); and
said guiding means comprises tracks where said actuator moves along said tracks
so that when the leading and the tailing edges of a printed coil of said actuator are aligned with two consecutive, the first and the second, printed coils or magnets of said stator(s), respectively, said printed coil of said actuator has the same polarity with said first printed coil or magnet and has the opposite polarity with said second printed coil or magnet; hence,
said actuator receives electromagnetic force from said stator(s) to move along said tracks in the desired direction; and
said actuator moves in the reverse direction when the polarity of the current applied to the printed coils of said actuator is reversed.

5. The closure of claim 2 wherein
said driving device is a linear motor;
said lines of printed coils or lines of magnets of said stator(s) are straight rows of printed coils that have changeable and alternating polarities during the operation;
each printed coil of one of said stators is aligned with and has the same polarity with the corresponding one of the other said stator when there are two said stators;
said lines of printed coils or lines of magnets of said actuator are straight rows of printed coils or magnets that have fixed and alternating polarities during the operation;
the distance between the centers of two consecutive printed coils or magnets in a row of said actuator equals that between the centers of two consecutive printed coils in the aligned row(s) of said stator(s); and
said guiding means comprises tracks where said actuator moves along said tracks
so that, when the leading and the tailing edges of a printed coil of said stator(s) are aligned with two consecutive, the first and the second, printed coils or magnets of said actuator, respectively, said printed coil of said stator(s) has the same polarity with said second printed coil or magnet and has the opposite polarity with said first printed coil or magnet; hence,
said actuator receives electromagnetic force from said stator(s) to move along said tracks in the desired direction; and
said actuator moves in the reverse direction if the polarity of the current applied to the printed coils of said stator(s) is reversed.

6. The closure of claim 2 wherein
said driving device is a rotary motor;
said lines of printed coils or lines of magnets of said stator(s) are concentric rings of printed coils or magnets that have fixed and alternating polarities during the operation;
each printed coil or magnet of one of said stators is aligned with and has the same polarity with the corresponding one of the other said stator when there are two said stators;
said lines of printed coils or lines of magnets of said actuator are concentric rings of printed coils that have changeable and alternating polarities during the operation;
the angular distance between the centers of two consecutive printed coils in a ring of said actuator equals that between the centers of two consecutive printed coils or magnets in the aligned ring(s) of said stator(s);
said guiding means is an axle that passes through the centers of all concentric rings of said actuator and said stator(s) and is the rotating center of said actuator
so that, when the leading and the tailing edges of a printed coil of said actuator are aligned with two consecutive, the first and the second, printed coils or magnets of said stator(s), respectively, said printed coil of said actuator has the same polarity with said first printed coil or magnet and has the opposite polarity with said second printed coil or magnet; hence,
said actuator receives electromagnetic force from said stator(s) to rotate with said axle as the rotating center in the desired direction; and
said actuator rotates in the reverse direction if the polarity of the current applied to the printed coils of said actuator is reversed.

7. The closure of claim 2 wherein
said driving device is a rotary motor;
said lines of printed coils or lines of magnets of said stator(s) are concentric rings of printed coils that have changeable and alternating polarities during the operation;
each printed coil of one of said stators is aligned with and has the same polarity with the corresponding one of the other stator when there are two said stators;
said lines of printed coils or lines of magnets of said actuator are concentric rings of printed coils or magnets that have fixed and alternating polarities during the operation;
the angular distance between the centers of two consecutive printed coils or magnets in a ring of said actuator equals that between the centers of two consecutive printed coils in the aligned ring(s) of said stator(s);
said guiding means is an axle that passes through the centers of all concentric rings of said actuator and said stator(s) and is the rotating center of said actuator;
so that, when the leading and the tailing edges of a printed coil of said stator(s) are aligned with two consecutive, the first and the second, printed coils or magnets of said actuator, respectively, said printed coil of said stator(s) has the same polarity with said second printed coil or magnet and has the opposite polarity with said first printed coil or magnet; hence,
said actuator receives electromagnetic force from said stator(s) to rotate with said axle as the rotating center in the desired direction; and
said actuator rotates in the reverse direction if the polarity of the current applied to the printed coils of said stator(s) is reversed.

8. The closure of claim 2 wherein
said driving device is an electromagnetic driver;
said lines of printed coils or lines of magnets of said actuator and said stator(s) are straight rows of printed coils or magnets that have alternating polarities in each row during the operation;
each printed coil or magnet of one of said stators is aligned with and has the opposite polarity with the corresponding one of the other stator when there are two stators;
each coil or magnet of said actuator is aligned with the corresponding printed coil(s) or magnet(s) of said stator(s);
said guiding means comprises tracks perpendicular with each row of said actuator and said stator(s) and said actuator moves along said tracks
so that each coil or magnet of said actuator is pushed and/or pulled by the aligned printed coil(s) or magnet(s) of said stator(s) when the electrical current is applied to the printed coils of said actuator and/or said stator(s);
said actuator receives electromagnetic force from said stator(s) in the direction along said tracks; hence,
said controller controls said actuator to move back and forth along said tracks by applying the electrical current with appropriate polarities to the printed coils of said stator(s) and said actuator.

9. The closure of claim 2 wherein said printed electromagnetic driving device further comprises
a polarity changing means to change the electromagnetic polarities of the printed coils of said stator(s) and/or said actuator at the appropriate moments of time.

10. The closure of claim 9 wherein
said driving device is a linear motor or a linear step motor;
there are two said stators; said lines of printed coils or lines of magnets of said stators are straight rows of printed coils that have changeable and alternating polarities during the operation;
said lines of printed coils or lines of magnets of said actuator are straight rows of printed coils or magnets that have fixed and alternating polarities during the operation;
the distance between the centers of two consecutive printed coils or magnets in a row of said actuator equals that between the centers of two consecutive printed coils in the corresponding row of either one of said stators;
the printed coils of the two said stators are not aligned; and
said guiding means comprises tracks where said actuator moves along said tracks
where, when any printed coils of one of said stators are aligned with any printed coils or magnets of said actuator, the electromagnetic polarities of the former are changed to be the opposites of the latter by said polarity changing means
so that, when the leading and the tailing edges of a printed coil of said stators are aligned with two consecutive, the first and the second, printed coils or magnets of said actuator, respectively, said printed coil of said stators has the same polarity with said second printed coil or magnet and has the opposite polarity with said first printed coil or magnet; hence,
said actuator receives electromagnetic force from said stators and moves along said tracks in the desired direction;
said actuator either continues to move to the limit or moves specific steps where said controller counts the number of times that said polarity changing means changes the polarities of the printed coils of said stators and stops the electrical current when said actuator moves enough steps; and
said actuator moves in the reverse direction if the polarity of the current applied to the printed coils of said stators is reversed when the printed coils of said stators are not aligned with the printed coils or magnets of said actuator.

11. The closure of claim 9 wherein
said driving device is a linear motor or a linear step motor;
there are two said stators;
said lines of printed coils or lines of magnets of said stators and said actuator are straight rows of printed coils that have changeable and alternating polarities during the operation;
the distance between the centers of two consecutive printed coils in a row of said actuator equals that between the centers of two consecutive printed coils in the corresponding rows of said stators;
the printed coils of the two said stators are not aligned; and
said guiding means comprises tracks where said actuator moves along said tracks
where, when any printed coils of one of said stators are aligned with any printed coils of said actuator, the electromagnetic polarities of the latter are changed to be the opposites of the former and the polarities of the printed coils of the other stator are reversed by said polarity changing means
so that, when the leading and the tailing edges of a printed coil of said actuator are aligned with two consecutive, the first and the second, printed coils of said stators, respectively, said printed coil of said actuator has the same polarity with said first printed coil and has the opposite polarity with said second printed coil; hence,
said actuator receives electromagnetic force from said stators to move along said tracks in the desired direction;
said actuator either continues to move to the limit or moves specific steps where said controller counts the number of times that said polarity changing means changes the polarities of the printed coils of said actuator and stops the electrical current when said actuator moves enough steps; and
said actuator moves in the reverse direction if the polarity of the current applied to the printed coils of said actuator or to the printed coils of said stators is reversed when the printed coils of said stators are not aligned with the printed coils of said actuator.

12. The closure of claim 9 wherein
said driving device is a rotary motor or a rotary step motor;
there are two said stators;
said lines of printed coils or lines of magnets of said stators are concentric rings of printed coils that have changeable and alternating polarities during the operation;
said lines of printed coils or lines of magnets of said actuator are concentric rings of printed coils or magnets that have fixed and alternating polarities during the operation;
the angular distance between the centers of two consecutive printed coils or magnets in a ring of said actuator equals that between the centers of two consecutive printed coils in the corresponding rings of said stators;
the printed coils of said stators are not aligned; and
said guiding means is an axle that passes through the centers of all concentric rings of said actuator and said stators and is the rotating center of said actuator
where, when any printed coils of one of said stators are aligned with the printed coils or magnets of said actuator, the electromagnetic polarities of the former are changed to be the opposites of the latter by said polarity changing means
so that, when the leading and the tailing edges of a printed coil of said stators are aligned with two consecutive, the first and the second, printed coils or magnets of said actuator, respectively, said printed coil of said stators has the same polarity with said second printed coil or magnet and has the opposite polarity with said first printed coil or magnet; hence,
said actuator receives electromagnetic force from said stators to rotate with said axle as the rotating center in the desired direction;
said actuator either rotates continuously or rotates specific steps where said controller counts the number of times that said polarity changing means changes the polarities of the printed coils of said stators and stops the electrical current when said actuator is moved enough steps; and
said actuator rotates in the reverse direction if the polarity of the current applied to the printed coils of said stators is reversed when the printed coils of said stators are not aligned with the printed coils or magnets of said actuator.

13. The closure of claim 9 wherein
said driving device is a rotary motor or a rotary step motor;
there are two said stators;
said lines of printed coils or lines of magnets of said actuator and said stators are concentric rings of printed coils that have changeable and alternating polarities during the operation;
the angular distance between the centers of two consecutive printed coils in a ring of said actuator equals that between the centers of two consecutive printed coils in the corresponding rings of said stators;
the printed coils of said stators are not aligned; and
said guiding means is an axle that passes through the centers of all concentric rings of said actuator and said stators and is the rotating center of said actuator
where, when the printed coils of one of said stators are aligned with the printed coils of said actuator, the electromagnetic polarities of the latter are changed to be the opposites of the former and the polarities of the printed coils of the other stator are reversed by said polarity changing means
so that, when the leading and the tailing edges of a printed coil of said actuator are aligned with two consecutive, the first and the second, printed coils of said stators, respectively, said printed coil of said actuator has the same polarity with said first printed coil and has the opposite polarity with said second printed coil; hence,
said actuator receives electromagnetic force from said stators to rotate with said axle as the rotating center in the desired direction;
said actuator either rotates continuously or rotates specific steps where said controller counts the number of times that said polarity changing means changes the polarities of the printed coils of said actuator and stops the electrical current when said actuator is moved enough steps; and
said actuator rotates in the reverse direction if the polarity of the current applied to the printed coils of said actuator or said stators is reversed when the printed coils of said stators are not aligned with the printed coils of said actuator.

14. The closure of claim 9 wherein
said driving device is a linear motor or a linear step motor;
said lines of printed coils or lines of magnets of said actuator are straight rows of printed coils or magnets that have fixed and alternating polarities during the operation;
said lines of printed coils or lines of magnets of said stator(s) are straight rows of printed coils that have changeable polarities during the operation;
each printed coil of one of said stators is aligned with and has the same electromagnetic polarity with the corresponding one of the other stator if there are two said stators;
the distance between the centers of two consecutive printed coils or magnets in a row of said actuator is greater than a half of but not equal to that between the centers of two consecutive printed coils in the aligned row(s) of said stator(s); and
said guiding means comprises tracks where said actuator moves along said tracks
where, when the center of any one printed coil of said stator(s) is aligned with the center of a printed coil or magnet of said actuator, the electromagnetic polarity of the former is changed to be the opposite of the latter by said polarity changing means
so that, when the leading and the tailing edges of a printed coil of said stator(s) are aligned with two consecutive, the first and the second, printed coils or magnets of said actuator, respectively, said printed coil of said stator(s) has the same polarity with said second printed coil or magnet and has the opposite polarity with said first printed coil or magnet; hence,
said actuator receives net electromagnetic force from said stator(s) to move along said tracks in the desired direction;
said actuator either continues to move to the limit or moves specific steps where said controller counts the number of times that said polarity changing means changes the polarities of the printed coils of said stator(s) and stops the electrical current when said actuator is moved enough steps; and
said actuator moves in the reverse direction if the polarity of the current applied to the printed coils of said stator(s) that are not aligned with the printed coils or magnets of said actuator is reversed.

15. The closure of claim 9 wherein
said driving device is a linear motor or a linear step motor;
said lines of printed coils or lines of magnets of said actuator are straight rows of printed coils that have changeable polarities during the operation;
said lines of printed coils or lines of magnets of said stator(s) are straight rows of printed coils or magnets that have fixed and alternating polarities during the operation;
each printed coil or magnet of one of said stators is aligned with and has the same electromagnetic polarity with the corresponding one of the other stator if there are two said stators;
the distance between the centers of two consecutive printed coils or magnets in a row of said stator(s) is greater than a half of but not equal to that between the centers of two consecutive printed coils of said actuator in the aligned row; and
said guiding means comprises tracks where said actuator moves along said tracks
where, when the center of any one printed coil of said actuator is aligned with the center of a printed coil or magnet of said stator(s), the electromagnetic polarity of the former is changed to be the opposite of the latter by said polarity changing means
so that, when the leading and the tailing edges of a printed coil of said actuator is aligned with two consecutive, the first and the second, printed coils or magnets of said stator(s), said printed coil of said actuator has the same polarity with said first printed coil or magnet and has the opposite polarity with said second printed coil or magnet; hence,
said actuator receives net electromagnetic force from said stator(s) to move along said tracks in the desired direction;
said actuator either continues to move to the limit or moves specific steps where said controller counts the number of times that said polarity changing means changes the polarities of the printed coils of said actuator and stops the electrical current when said actuator is moved enough steps; and
said actuator moves in the reverse direction if the polarity of the current applied to the printed coils of said actuator that are not aligned with the printed coils or magnets of said stator(s) is reversed.

16. The closure of claim 9 wherein
said driving device is a rotary motor or a rotary step motor;
said lines of printed coils or lines of magnets of said actuator are concentric rings of printed coils or magnets that have fixed and alternating polarities during the operation;
said lines of printed coils or lines of magnets of said stator(s) are concentric rings of printed coils that have changeable polarities during the operation;
each printed coil of one of said stators is aligned with and has the same electromagnetic polarity with the corresponding one of the other stator if there are two said stators;
the angular distance between the centers of two consecutive printed coils or magnets in a ring of said actuator is greater than a half of but not equal to that between the centers of two consecutive printed coils in the aligned ring(s) of said stator(s); and
said guiding means is an axle that passes through the centers of all concentric rings of said actuator and said stator(s) and is the rotating center of said actuator
where, when the center of any one printed coil of said stator(s) is aligned with the center of a printed coil or magnet of said actuator, the electromagnetic polarity of the former is changed to be the opposite of the latter by said polarity changing means
so that, when the leading and the tailing edges of a printed coil of said stator(s) are aligned with two consecutive, the first and the second, printed coils or magnets of said actuator, respectively, said printed coil of said stator(s) has the same polarity with said second printed coil or magnet and has the opposite polarity with said first printed coil or magnet; hence,
said actuator receives electromagnetic force from said stator(s) to rotate with said axle as the rotating center in the desired direction;
said actuator either rotates continuously or rotates specific steps where said controller counts the number of times that said polarity changing means changes the polarities of the printed coils of said stator(s) and stops the electrical current when said actuator is moved enough steps; and
said actuator rotates in the reverse direction if the polarity of the current applied to the printed coils of said stator(s) that are not aligned with the printed coils or magnets of said actuator is reversed.

17. The closure of claim 9 wherein
said driving device is a rotary motor or a rotary step motor;
said lines of printed coils or lines of magnets of said actuator are concentric rings of printed coils that have changeable polarities during the operation;
said lines of printed coils or lines of magnets of said stator(s) are concentric rings of printed coils or magnets that have fixed and alternating polarities during the operation;
each printed coil or magnet of one of said stators is aligned with and has the same electromagnetic polarity with the corresponding one of the other stator if there are two said stators;
the angular distance between the centers of two consecutive printed coils or magnets in a ring of said stator(s) is greater than a half of but not equal to that between the centers of two consecutive printed coils in the aligned ring of said actuator; and
said guiding means is an axle that passes through the centers of all concentric rings of said actuator and said stator(s) and is the rotating center of said actuator
where, when the center of any one printed coil of said actuator is aligned with the center of a printed coil or magnet of said stator(s), the electromagnetic polarity of the former is changed to be the opposite of the latter by said polarity changing means
so that, when the leading and the tailing edges of a printed coil of said actuator is aligned with two consecutive, the first and the second, printed coils or magnets of said stator(s), said printed coil of said actuator has the same polarity with
said first printed coil or magnet and has the opposite polarity with said second printed coil or magnet; hence,
said actuator receives electromagnetic force from said stator(s) to rotate with said axle as the rotating center in the desired direction;
said actuator either rotates continuously or rotates specific steps where said controller counts the number of times that said polarity changing means changes the polarities of the printed coils of said actuator and stops the electrical current when said actuator is moved enough steps; and
said actuator rotates in the reverse direction if the polarity of the current applied to the printed coils of said actuator is reversed.

18. The closure of claim 9 wherein said polarity changing means further comprising:
stator contacts that are stationary in said housing; and
actuator contacts that move along with said actuator
where a stator contact and an actuator contact are contacted when any set of printed coils of said actuator or said stator(s) need to change the polarities
so that said controller detects which stator contact and which actuator contact are connected to determine which set of printed coils need to change the electrical polarity and changes it; and said actuator continues to move after the changing is done.

19. The closure of claim 9 wherein said polarity changing means further comprising:
pairs of coil contacts on each said coil PCB where each pair of said coil contacts are connected to the two terminals of the windings of the set of connected printed coils that are operated and whose electromagnetic polarities are changed at the same time; and
pairs of power contacts where each pair of said power contacts are connected to the positive and the negative of the power source during the operation
where each set of printed coils that are operated and whose electromagnetic polarities are changed at the same time has one pair of said coil contacts that are connected to one pair of said power contacts with desired electrical polarities during operation
so that, when the polarities of said set of printed coils need to be changed, the associated pair of coil contacts disconnect from the pair of power contacts being connected and re-connect to another pair of power contacts with opposite electrical polarity; and said actuator continues to move after the re-connection is done.

20. The closure of claim 9 wherein said polarity changing means further comprising:
light emitters; and
light detectors
where either said light emitters or said light detectors are installed to be stationary and the other are installed to move along with said actuator; and a light detector detects the light when any set of printed coils of said actuator or said stator(s) need to change the polarities
so that said controller detects which light emitter emits the light and which light detector detects the light or counts the number of times that said light detectors detect the light since the initial status to determine which set of printed coils need to change the electrical polarity and changes it; and said actuator continues to move after the changing is done.

21. The closure of claim 9 wherein said polarity changing means further comprising:
light emitters;
light detectors; and
light reflectors
where either said light emitters and said light detectors are installed to be stationary and said light reflectors are installed to move along with said actuator or said light reflectors are installed to be stationary and said light emitters and said light detectors are installed to move along with said actuator; and a light detector detects the light emitted by one of said light emitters and reflected by one of said light reflectors when any set of printed coils of said actuator or said stator(s) need to change the polarities
so that said controller detects which light emitter emits the light, which light reflector reflects the light, and which light detector detects the light or counts the number of times that said light detectors detect the light since the initial status to determine which set of printed coils need to change the electrical polarity and changes it; and said actuator continues to move after the changing is done.
